(19) United States
(12) Patent Application Publication
(10) Pub. No.: US 2022/0376613 A1
(43) Pub. Date: Nov. 24, 2022

(54) POWER CONVERTER

(71) Applicant: SUPPLY DESIGN LIMITED, Dunfermline, Fife (GB)

(72) Inventor: Craig Alexander Britton, Dunfermline, Fife (GB)

(73) Assignee: SUPPLY DESIGN LIMITED, Dunfermline, Fife (GB)

(21) Appl. No.: 16/619,889

(22) PCT Filed: Jun. 5, 2018
(86) PCT No.: PCT/GB2018/051528

§ 371 Date: Dec. 5, 2019

(30) Foreign Application Priority Data
Jun. 5, 2017 (GB) 1708924.4

(51) Int. Cl. H02M 1/42; H02M 1/10; H02M 1/44; H02M 7/23

(52) U.S. Cl. CPC H02M 1/4216; H02M 1/10; H02M 1/44; H02M 7/23

(57) ABSTRACT

The invention provides a power converter for converting a three-phase alternating current (AC) supply to a direct current (DC) output, the power converter comprising: a first selector configured to select one of the highest, the second highest or the lowest instantaneous phase to phase voltages of the three-phase supply to provide a first power rail; a second selector configured to select a different one of the highest, the second highest or the lowest instantaneous phase to phase voltages of the three-phase supply to provide a second power rail; a first transformer coupled to the first power rail; a second transformer coupled to the second power rail; a combiner configured to combine the outputs of the first and second transformers to provide the DC output; and a duty cycle controller configured to vary duty cycles of the first and/or second transformers to thereby vary the relative contributions of the first and second power rails to the DC output.

### FIELD OF THE INVENTION

The invention relates to: a power converter; a method of converting a three-phase alternating current (AC) supply to a (typically isolated) direct current (DC) output; a phase reference generator; and a method of providing a phase angle reference indicative of the instantaneous phase of a three-phase alternating current (AC) supply.

### BACKGROUND TO THE INVENTION

Many applications require the conversion of three-phase AC power to a regulated DC output voltage or current, including, but not limited to, domestic and industrial utilisation equipment operating from AC mains supplies (particularly for higher power applications), utilisation equipment operating from a local generator such as on ships or aircraft and utilisation equipment operating from renewable energy sources such as wind turbines.

In all of the above cases, it is highly desirable to minimise the reactive and harmonic content of the supply current drawn by the utilisation equipment operating to avoid unproductive loading on the source and minimise noise propagation to other utilisation equipment on the same supply line. In most cases there are mandatory limits placed either by the suppliers of the AC mains supply or systems authority for local generator systems specifying both the power factor and harmonic content permissible. It is anticipated that as technology improves, the specification requirements will be tightened in the future to improve generator and power transmission efficiency.

EP2067246 describes a power converter for converting a three-phase AC supply to a DC output. Two bulk power rails are produced from the incoming three-phase line voltage. The first bulk power rail is produced from a standard three-phase diode bridge to produce the highest instantaneous phase-to-phase voltage. The second bulk power rail is produced by selective rectification using electronic switches to produce the second highest instantaneous phase-to-phase voltage. The DC output is generated by operating high frequency inverters off the first and second bulk power rails, and combining the output voltages in a ratio determined by the relative turns ratios of first and second transformers coupled between the inverters and the DC output. Rectifying and filtering the sum of the secondary voltages of the transformers provides the DC output voltage. Higher levels of harmonic reduction were achieved in EP2067246 by adding additional pairs of secondary windings with different turns ratios in parallel with the secondary windings of the first and second transformers to change the transfer function in a step manner depending on line phase. However, additional pairs of secondary windings add size, weight and cost to the converter and there is a practical limit as to how many additional pairs of secondary windings can be included (typically three or four). There is thus a limit to the benefit that can be achieved in practice with this approach.

Accordingly, it would be desirable to provide a power converter with a better way to minimise the reactive and harmonic content of the supply current it draws, and indeed to minimise voltage ripple on the DC output.

It is also helpful, and in some cases necessary, for power converters to have a phase angle reference which is indicative of an instantaneous phase of the three-phase supply so as to be able to synchronise the power converter with line phase. “Phase locked loop and synchronization methods for grid interfaced converters: a review”, PRZEGLĄD ELEKTROTECHNICZNY (Electrical Review), ISSN 0033-2097, R. 87 NR April 2011 describes a zero-crossing detection method (ZCD), where a zero crossing is detected every period. However, this method does not provide sufficiently accurate synchronisation in some circumstances. Accordingly, some aspects of the invention relate to the provision of a more accurate phase angle reference.

### SUMMARY OF THE INVENTION

A first aspect of the invention provides a power converter for converting a three-phase alternating current (AC) supply to a (typically isolated, typically galvanically isolated) direct current (DC) output, the power converter comprising: a first selector configured to select one of the highest, the second highest or the lowest instantaneous phase to phase voltages of the three-phase supply to provide a first power rail; a second selector configured to select a different one of the highest, the second highest or the lowest instantaneous phase to phase voltages of the three-phase supply to provide a second power rail; a first transformer coupled to the first power rail; a second transformer coupled to the second power rail; a combiner configured to combine the outputs of the first and second transformers to provide the DC output; and a duty cycle controller configured to vary duty cycles of the first and/or second transformers (e.g. as a function of line phase, typically within a phase cycle of the three-phase AC supply, typically relative to each other) to thereby vary the relative (e.g. power) contributions of the first and second power rails (and typically thereby the relative power contributions from the first, second and third phases of the three-phase AC supply) to the DC output (typically within a phase cycle of the three phase AC supply, typically as a function of line phase).

A second aspect of the invention provides a method of converting a three-phase alternating current (AC) supply to a (typically isolated, typically galvanically isolated) direct current (DC) output, the method comprising: selecting one of the highest, the second highest or the lowest instantaneous phase to phase voltages of the three-phase supply to provide a first power rail; selecting a different one of the highest, the second highest or the lowest instantaneous phase to phase voltages of the three-phase supply to provide a second power rail; (electrically) coupling (e.g. conductively connecting) the first power rail to a first transformer; (electrically) coupling (e.g. conductively connecting) the second power rail to a second transformer; combining outputs of the first and second transformers to provide the DC output; and varying duty cycles of the first and/or second transformers (e.g. as a function of line phase, typically within a phase cycle of the three-phase AC supply, typically relative to each other) to thereby vary the relative (typically power) contributions of the first and second power rails (and typically thereby the relative power contributions from the first, second and third phases of the three-phase AC supply) to the DC output (typically within a phase cycle of the three phase AC supply, typically as a function of line phase).

By varying the duty cycles of the first and/or second transformers to thereby vary the relative contributions of the first and second power rails to the DC output, the currents provided by the first, second and third phases of the three-phase supply are thereby correspondingly controlled.

It may be that the duty cycle controller is configured to vary (or the method may comprise varying) the duty cycles of the first and/or second transformers to vary the total contribution(s) of the first and/or second power rails to the DC output.

It may be that the duty cycle controller is configured to vary (or the method may comprise varying) the duty cycles of the first and/or second transformers to maintain a constant input power to the converter from the three phase AC supply, within an error (e.g. fluctuation from constant or mean level) of less than 10%, preferably less than 5%, preferably less than 3% (e.g. for one or more (e.g. two or more consecutive) cycles of line phase).

It may be that the duty cycle controller is configured to vary (or the method may comprise varying) the duty cycles of the first and/or second transformers to maintain a constant output power from the converter, with an error (e.g. fluctuation from constant or mean level) of less than 10%, preferably less than 5%, preferably less than 3% (e.g. for one or more (e.g. two or more consecutive) cycles of line phase).

It may be that the duty cycle controller is configured to vary (or the method may comprise varying) the duty cycles of the first and/or second transformers to reduce a magnitude of a reactive current in at least one (or two or each) of the phases of the three phase AC supply.

Typically the duty cycle controller is configured to vary (or the method may comprise varying) the duty cycles of the first and/or second transformers to vary the relative contributions of the first and second power rails to the DC output to thereby reduce a voltage ripple of the DC output and/or to thereby reduce the line current harmonic content of the three-phase supply (e.g. as compared to when the duty cycles of the first and second transformers are constant).

It may be that the duty cycle controller is configured to vary (or the method may comprise varying) the duty cycles of the said first and/or second transformers for each magnetic flux cycle of the said transformers.

Typically the duty cycle controller is configured to vary (or the method may comprise varying) the duty cycles of the first and/or second transformers to thereby vary the relative contributions of the first and second power rails to the DC output in order to correct a power factor of each of one or more or each of the phases of the three phase supply (e.g. a power factor lead caused by an electromagnetic interference filter, e.g. provided at the input to the converter). It may be that the duty cycle controller is configured to vary (or the method may comprise varying) the duty cycles of the first and/or second transformers to thereby cause a phase shift (e.g. phase lag) to the currents drawn from the first and/or second power rails to thereby correct the power factor of one or more or each of the phases of the three phase AC supply (e.g. to balance out the leading power factor caused by an electromagnetic interference filter, e.g. provided at the input to the converter).

Typically the duty cycle controller is configured to vary (or the method may comprise varying) the duty cycles of the first and/or second transformers to thereby maintain the power factor of each of one or more or each of the phases of the three phase supply at greater than 0.8, yet more preferably greater than 0.85, yet more preferably greater than 0.9, yet more preferably greater than 0.95, yet more preferably greater than 0.99, typically for one or more (e.g. two or more consecutive) cycles of magnetic flux of the said first and/or second transformers, preferably for twelve or more (more preferably twenty four or more, even more preferably thirty six or more, yet more preferably forty eight or more) values (e.g. integer values in degrees) of line phase of the three-phase supply for each of one or more (or each) 360° cycles of line phase of the three-phase supply, e.g. under steady state load conditions.

Typically the duty cycle controller is configured to vary (or the method may comprise varying) the duty cycles of the first and/or second transformers to thereby maintain the power factor of one or more or each phase of the three phase supply at greater than 0.8, yet more preferably greater than 0.85, yet more preferably greater than 0.9, yet more preferably greater than 0.95, yet more preferably greater than 0.99 for one or more (e.g. two or more consecutive) cycles, or each cycle, of line phase of the three-phase AC supply, e.g. under steady state load conditions.

Typically the duty cycle controller is configured to vary (or the method may comprise varying) the duty cycles of the first and/or second transformers to thereby maintain the total harmonic distortion of the line current drawn from each of one or more or each of the phases of the three-phase AC supply at less than 10%, more preferably less than 7%, yet more preferably less than 5%, yet more preferably less than 3%, yet more preferably less than 2%, e.g. for one or more (e.g. two or more consecutive) cycles (or each cycle) of line phase of the three-phase AC supply e.g. under steady state load or constant conduction conditions.

Typically the duty cycle controller is configured to vary (or the method may comprise varying) the duty cycles of the first and/or second transformers such that the current flowing into or out of a first one of the three phases of the three-phase AC supply is proportional to the sum of the instantaneous voltages between the said first phase and the other two phases, the said current typically having a total harmonic distortion of less than 10%, preferably less than 7%, more preferably less than 5%, yet more preferably less than 3%, yet more preferably less than 2%, preferably for one or more (e.g. two or more consecutive) cycles of line phase of the three-phase supply, e.g. under steady state load conditions.

Typically the duty cycle controller is configured to vary (or the method may comprise varying) the duty cycles of the first and/or second transformers such that the magnitude of the current drawn from each of one or more (or each) of the three phases of the three-phase supply varies with greater resolution than if the duty cycles of the first and second transformers were constant.

Typically the duty cycle controller is configured to vary (or the method may comprise varying) the duty cycles of the first and/or second transformers such that the magnitude of the phase voltage of each of one or more (or each) of the three phases of the three-phase supply varies with greater resolution than if the duty cycles of the first and second transformers were constant.

Typically the duty cycle controller is configured to vary (or the method may comprise varying) the duty cycles of the first and second transformers.

Typically the first power rail comprises a first power rail portion and a first return power rail portion. Typically the said one of the highest, the second highest or the lowest instantaneous phase to phase voltages selected by the first selector is provided between the first power rail portion and the first return power rail portion. Typically the phase to phase voltage selected by the first selector is provided by the voltage difference between a first phase voltage of the three phase AC supply and a second phase voltage of the three phase AC supply, the first phase voltage being greater than the second phase voltage. Typically, for different portions of a 360° phase cycle of the AC supply, the first phase voltage is provided by different phases of the three phase AC supply. Typically, for different portions of a 360° phase cycle of the AC supply, the second phase voltage is provided by different phases of the three phase AC supply. Typically the first phase voltage is electrically coupled to the first power rail portion and the second phase voltage is electrically coupled to the first return power rail portion.

Typically the second power rail comprises a second power rail portion and a second return power rail portion. Typically the said other of the highest, the second highest or the lowest instantaneous phase to phase voltages selected by the second selector is provided between the second power rail portion and the second return power rail portion. Typically the phase to phase voltage selected by the second selector is provided by the voltage difference between a third phase voltage of the three phase AC supply and a fourth phase voltage of the three phase AC supply, the third phase voltage being greater than the fourth phase voltage. It may be that, for different portions of a 360° phase cycle of the AC supply, the third phase voltage is provided by different phases of the three phase AC supply. It may be that, for different portions of a 360° phase cycle of the AC supply, the fourth phase voltage is provided by different phases of the three phase AC supply. Typically the third phase voltage is electrically coupled to the second power rail portion and the fourth phase voltage is electrically coupled to the second return power rail portion.

Typically the method comprises providing the first power rail by selecting the said one of the highest, the second highest or the lowest instantaneous phase to phase voltages between a first power rail portion and a first return power rail portion of the first power rail. Typically the method comprises providing the second power rail by selecting the said other of the highest, the second highest or the lowest instantaneous phase to phase voltages between a second power rail portion and a second return power rail portion of the second power rail.

It may be that the first and third phase voltages are provided by the same (e.g. the highest voltage) phase of the three phase AC supply and the second and fourth phase voltages are provided by different phases of the three phase AC supply (e.g. at any given line phase). Alternatively, it may be that the second and fourth phase voltages are provided by the same (e.g. the lowest voltage) phase of the three phase AC supply and the first and third phase voltages are provided by different phases of the three phase AC supply (e.g. at any given line phase). Thus, it may be that the first and second power rails have phase voltages of the AC supply in common and phase voltages of the AC supply which are not in common (e.g. at any given line phase).

It may be that, for one or more or each (typically complete) 360° phase cycle(s) of the AC supply or permanently, the first phase voltage is the highest instantaneous phase voltage and the second phase voltage is the lowest instantaneous phase voltage.

It may be that, for one or more or each (typically complete) 360° phase cycle(s) of the AC supply or permanently, the third phase voltage is the highest instantaneous phase voltage. It may be that, for one or more or each (typically complete) 360° phase cycle(s) of the AC supply or permanently, the fourth phase voltage is the second highest instantaneous phase voltage. It may be that the second selector is configured to select a phase to phase voltage between the highest instantaneous phase voltage (as the third phase voltage) and the second highest instantaneous phase voltage (as the fourth phase voltage) for one or more or each (typically complete) 360° phase cycle of the AC supply or permanently. It may be that a capacitor is connected between the first power rail portion and the second power rail portion.

It may be that, for one or more or each (typically complete) 360° phase cycle(s) of the AC supply or permanently, the fourth phase voltage is the lowest instantaneous phase voltage. It may be that, for one or more or each (typically complete) 360° phase cycle(s) of the AC supply or permanently, the third phase voltage is the second highest instantaneous phase voltage. It may be that the second selector is configured to select a phase to phase voltage between the lowest instantaneous phase voltage (as the fourth phase voltage) and the second highest instantaneous phase voltage (as the third phase voltage) for one or more or each (typically complete) 360° phase cycle of the AC supply or permanently. It may be that a capacitor is connected between the first power rail return portion and the second power rail return portion.

Thus, in some embodiments, the second selector is configured to select the second highest instantaneous phase to phase voltage during a first portion of a (or a first portion of each of one or more or each) 360° cycle of the three phase AC supply and to select the lowest instantaneous phase to phase voltage during a second portion of the (or a second portion of each) said 360° cycle of the three phase AC supply different from the first portion.

It may be that the duty cycles of the first and/or second transformers are varied (or the method may comprise varying the duty cycles of the first and/or second transformers) such that the ratio of the magnitude of the current drawn (e.g. by the DC output) from the second power rail to the magnitude of the current drawn (e.g. by the DC output) from the first power rail is equal to the ratio of the sine of the instantaneous line phase angle to the sine of a compensated instantaneous line phase angle, the said compensated instantaneous line phase angle being the said instantaneous phase angle compensated for a phase difference between the phase voltage of the second power rail not in common with the first power rail and the phase voltage of the first power rail not in common with the second power rail (typically by adding a leading phase difference between them or subtracting a lagging phase difference between them), typically at more than twelve (preferably more than twenty four, more preferably more than thirty six, more preferably more than forty eight) values (e.g. integer values in degrees) of line phase of the three-phase supply for each of one or more (or each) 360° cycles of line phase of the three-phase supply, e.g. under steady state load conditions.

Typically the first transformer comprises a primary winding coupled to a secondary winding.

Typically the second transformer comprises a primary winding coupled to a secondary winding.

Typically the first power rail is electrically connected to the primary winding of the first transformer during active portions of the duty cycle of the first transformer.

Typically the second power rail is electrically connected to the primary winding of the second transformer during active portions of the duty cycle of the second transformer.

Typically the secondary windings of the first and second transformers are connected together in series. The electrical currents flowing through the secondary windings of the first and second transformers are thus typically equal in use.

Typically the secondary windings of the first and second transformers are connected to (typically in series with) an inductor.

Typically the combiner and the inductor are comprised in a buck type output stage of the converter. Typically an AC component of the inductor current is between 30% and 70% of the DC component of the inductor current at maximum load, more preferably between 40% and 60%, yet more preferably between 45% and 55%, yet more preferably between 48% and 52%.

Typically the AC peak to peak variation on the current and/or output voltage of the DC output at full load is less than 50% (more preferably less than 25%, yet more preferably less than 10%, yet more preferably less than 1%) of the mean said current and/or voltage of the DC output.

It may be that the first transformer has a first turns ratio comprising the ratio of the number of turns of a primary winding of the first transformer to the number of turns of a secondary winding of the first transformer and the second transformer has a second turns ratio comprising the ratio of the number of turns of a primary winding of the second transformer to the number of turns of a secondary winding of the second transformer.

For a typical power converter of this kind (such as the one described in EP2067246), the first and second transformers are provided with identical, constant duty cycles. In this case, the relative contributions of the first and second transformers to the DC output is typically constant, and is determined by the first turns ratio relative to the second turns ratio. As the relative contributions of the first and second transformers to the DC output remains constant within a phase cycle of the three-phase AC supply, the line currents of the three-phase AC supply are typically constrained, which has the effect of increasing the harmonic content of the line currents of the three-phase AC supply. One way of mitigating this is to provide the first and second transformers with a plurality of secondary windings connected in parallel, and to connect each of the secondary windings of the first transformer in series with a corresponding secondary winding of the second transformer. The combiner which combines the outputs of the first and second transformers to provide the DC output is typically provided with a third selector configured to select the output from the series combination of secondary windings providing the greatest instantaneous output voltage. The numbers of turns in the secondary windings are chosen such that, for each series combination of secondary windings, the first and second transformers provide different relative contributions to the DC output. This eases the constraints on the line current of the three-phase AC supply to a degree, but the benefit that can be achieved by this approach is limited by the fact that, in practice, a maximum of three or four secondary turns can be provided for each transformer due to the bulk and expense introduced by the additional secondary turns.

By varying the relative contributions of the first and second transformers to the DC output by varying the duty cycles of the first and second transformers, the line current harmonic content can be reduced without introducing any additional pairs of secondary windings (thereby saving on bulk and expense). Furthermore, the relative contributions of the first and second transformers to the DC output can be varied with a finer granularity (e.g. the duty cycle of each transformer may be changed once per magnetic cycle of the transformer). This means that a far greater reduction in line current harmonic content can be achieved by this approach than by adding additional pairs of secondary windings, and at a significantly reduced size and cost.

It will be understood that the duty cycles of the first and second transformers are typically different from each other for at least a portion of a phase cycle of the three-phase supply. The duty cycles of the first and second transformers are typically different from each other for at least a majority of a phase cycle of the three-phase supply. The method may comprise varying the duty cycles of the first and second transformers such that they are different from each other for at least a portion of (typically a majority of) a phase cycle of the three-phase supply.

It will be understood that the first selector typically comprises a plurality of first (electrical) switches (e.g. diodes and/or FETs) configured to select the said one of the highest, the second highest or the lowest instantaneous phase to phase voltages.

It will be understood that the second selector typically comprises a plurality of second (electrical) switches (e.g. diodes and/or FETs) configured to select the said other one of the highest, the second highest or the lowest instantaneous phase to phase voltages.

It will be understood that the combiner typically comprises (electrical) combining circuitry configured to combine the outputs of the first and second transformers.

It may be that the duty cycle controller comprises electronic processing circuitry (e.g. a processor such as a microprocessor or analogue pulse width modulation circuitry), a digital signal processing (DSP) chip or a microcontroller. The duty cycle controller may further comprise computer program instructions loaded or loadable onto a memory of (and executed or executable by) the processing circuitry, DSP chip or microcontroller.

Typically the first transformer is coupled (or the method may comprise coupling the first transformer) to the first power rail by way of a first (power) inverter. Typically the second transformer is coupled (or the method may comprise coupling the second transformer) to the second power rail by way of a second (power) inverter.

The first inverter is typically configured to convert a first power rail voltage (between the first power rail portion and the first return power rail portion), which typically comprises a predominantly DC content, to a predominantly AC signal. Typically the said AC signal has a dominant component having a frequency of at least 1.5 kHz, preferably at least 50 kHz and more preferably at least 100 kHz (typically 100 kHz to 200 kHz). The higher the frequency of the AC signal, the smaller the (physical size of the) first transformer can be.

The second inverter is typically configured to convert a second power rail voltage (between the second power rail portion and the second return power rail portion), which typically comprises a predominantly DC content, to a predominantly AC signal. Typically the said AC signal has a dominant component having a frequency of at least 1.5 kHz, preferably at least 50 kHz and more preferably at least 100 kHz (typically 100 kHz to 200 kHz). The higher the frequency of the AC signal, the smaller the (physical size of the) second transformer can be.

It may be that the controller is configured to vary (or the method may comprise varying) the duty cycle of the first transformer by varying the duty cycle of the first inverter and/or to vary the duty cycle of the second transformer by varying the duty cycle of the second inverter.

Typically the first selector is configured to select (or the method may comprise selecting) the highest instantaneous phase to phase voltage of the three-phase supply to provide the first power rail.

The second selector is typically configured to select (or the method may comprise selecting) the second highest instantaneous phase to phase voltage of the three-phase supply to provide the second power rail.

It may be that the first selector comprises a full wave rectifier.

It may be that the second selector comprises a full wave rectifier.

It may be that the second selector comprises a plurality of switches for selecting the said different one of the highest, the second highest or the lowest instantaneous phase to phase voltages of the three-phase supply and a controller for controlling said switches. It may be that the duty cycle controller comprises the controller for controlling said switches.

It may be that the second selector comprises a plurality of switches and a full wave rectifier for selecting the said different one of the highest, the second highest or the lowest instantaneous phase to phase voltages of the three-phase supply and a controller for controlling said switches. For example, it may be that the said plurality of switches comprises: a first switch between the rectifier of the second selector and the first phase; a second switch between the rectifier of the second selector and the second phase; and a third switch between the rectifier of the second selector and the third phase.

Typically, the first power rail is provided by the highest instantaneous phase to phase voltage of the three-phase supply and the second power rail is provided by the second highest instantaneous phase to phase voltage of the three-phase supply.

Preferably the power converter comprises a hold-up storage element (e.g. capacitor) coupled to, and between, the first power rail and the second power rail.

It may be that (e.g. when the first power rail is provided by the highest instantaneous phase to phase voltage of the three-phase supply and the second power rail is provided by the second highest instantaneous phase to phase voltage of the three-phase supply) the minimum voltage across the first power rail is equal or substantially equal to the maximum voltage across the second power rail.

The hold-up storage element is typically coupled to the first and second power rails such that (e.g. the storage element is charged such that, or the method may comprise charging the storage element such that) a voltage across the storage element is (and typically remains, at least for a plurality of consecutive cycles of line phase) at or above a maximum voltage across the second power rail (and/or at or above a minimum voltage across the first power rail). Typically the storage element is further configured to provide (or the method may comprise the storage element providing) a source of electrical energy to the DC output (typically for a finite time period) responsive to a fault in (e.g. one or more or each phase of) the three-phase supply. Typically the hold-up storage element is configured so as to not affect any other circuitry of the power converter.

It may be that the controller is configured to: detect a fault in (e.g. one or more or each phase of) the three-phase AC supply; and to enter a hold-up mode responsive to the detection of the said fault. Where the second selector comprises a plurality of switches and a full wave rectifier, it may be that the controller is configured, when in the hold-up mode, to turn on all of the said switches (e.g. for the duration of the fault). In this way, it may be that the controller is configured to (passively) select the highest instantaneous phase to phase voltage from the three-phase AC supply, thereby maximising the chances of the converter maintaining the required output voltage.

Where the second selector comprises a plurality of bidirectional switches configured to select the said other of the highest, second-highest and lowest phase to phase voltages, it may be that the controller is configured, when in the hold-up mode, to open all of the said bidirectional switches (e.g. for the duration of the fault).

It may be that the method comprises: detecting a fault in (e.g. one or more or each phase of) the three-phase AC supply; and entering a hold-up mode responsive to the detection of the said fault. Where the second selector comprises a plurality of switches and a full wave rectifier, it may be that the method comprises, when in the hold-up mode: turning on all of the said switches (e.g. for the duration of the fault). In this way, the method may comprise (passively) select the highest instantaneous phase to phase voltage from the three-phase AC supply, thereby maximising the chances of the converter maintaining the required output voltage. Where the second selector comprises a plurality of bidirectional switches configured to select the said other of the highest, second-highest and lowest phase to phase voltages, it may be that the method comprises, when in the hold-up mode, opening all of the said bidirectional switches (e.g. for the duration of the fault).

Typically the hold-up storage element is coupled to, and between, the first and second power rails by way of a plurality of switches. The switches are typically configured to allow the hold-up storage element to be charged (or the method may comprise the switches opening and closing to allow the hold-up storage element to charge) to at least the maximum voltage across the second power rail and/or the minimum voltage across the first power rail during normal operation of the three-phase AC supply. The switches are typically configured to discharge (or the method may comprise discharging) the storage element through the first and/or second power rails responsive to a fault of (e.g. one or more or each phase of) the three-phase supply. It may be that the controller is configured to, in the said hold-up mode, change the states of (e.g. turn on) one or more switches (e.g. one or more switches between the holdup storage element and the first or second power rails and/or between the holdup storage element and the returns of the first or second power rails) to thereby permit energy from the holdup storage element to be supplied to the DC output. This may permit the holdup storage element to supply energy to the DC output by way of both the first and second power rails. Preferably at least some of the switches are passively activated (e.g. the switches may comprise a plurality of diodes), or the method may comprise passively actuating the switches. It may be that one or more of the said switches (e.g. two of the said switches) are actively actuated. It may be that the method comprises actively actuating (or the controller may be configured to actively actuate) one or more said actively actuated switches to thereby allow energy to be supplied from the holdup energy storage element to the DC output by way of both the first and second power rails. It may be that the hold-up storage element (e.g. a first plate of a hold-up capacitor) is coupled to the first power rail portion by a first diode and to the second power rail portion by a second diode. It may be that the second diode is an antiparallel diode of an actively actuated MOSFET. Typically the first diode is connected from the first power rail portion to the storage element (e.g. first plate of hold-up capacitor) with a first polarity and the second diode is connected from the second power rail portion to the storage element (e.g. first plate of hold-up capacitor) with a second polarity opposite the first polarity. Typically the hold-up storage element (e.g. a second plate of a hold-up capacitor) is coupled to the first return power rail portion by a third diode and to the second return power rail portion by a fourth diode. It may be that the fourth diode is an antiparallel diode of an actively actuated MOSFET. Typically the third diode is connected from the storage element (e.g. the said second plate of the hold-up capacitor) to the first return power rail portion with the said second polarity. Typically the fourth diode is connected from the storage element (e.g. the said second plate of the hold-up capacitor) to the second return power rail portion with the said first polarity.

Typically the power converter comprises a three-phase input and an electromagnetic interference filter in communication with the input.

Typically the electromagnetic interference filter is a low pass filter configured to inhibit (or the method may comprise the electromagnetic interference filter inhibiting) high frequency (e.g. greater than 1 kHz, typically greater than 5 kHz, typically 1 to 10kHz) harmonic signals from being injected back into the three-phase AC supply from the converter. Typically the electromagnetic interference filter is configured to attenuate (or the method may comprise attenuating) the fundamental switching frequency of the inverter(s) (and typically the higher frequency harmonics thereof) where provided. For a switching frequency of 150 kHz, the electromagnetic interference filter typically has a frequency response with a roll-off beginning in the range 1 kHz to 10 kHz. In the absence of the electromagnetic interference filter, high frequency harmonic signals injected back into the three-phase AC supply could interfere with the operation of other nearby equipment.

Typically the electromagnetic interference filter comprises one or more capacitors. Typically the electromagnetic interference filter further comprises one or more (e.g. damping) resistors and/or one or more (e.g. differential and/or common mode) inductors.

Typically the power converter comprises a first input for (or the method may comprise a first input of the power converter) receiving a first phase of the three phase supply. Typically the power converter comprises a second input for (or the method may comprise a second input of the power converter) receiving a second phase of the three phase supply. Typically the power converter comprises a third input for (or the method may comprise a third input of the power converter) receiving a third phase of the three phase supply.

Typically the electromagnetic interference filter comprises one or more capacitors provided between the first and second inputs. Typically the electromagnetic interference filter (additionally) comprises one or more capacitors provided between the first and third inputs. Typically the electromagnetic interference filter (additionally) comprises one or more capacitors provided between the second and third inputs.

It may be that the duty cycle controller is configured to vary (or the method may comprise varying) duty cycles of the first and/or second transformers (e.g. as a function of line phase, typically within a phase cycle of the three-phase AC supply, typically relative to each other) to thereby vary the relative contributions of the first and second power rails to the DC output in order to correct a power factor of one or more or each phase of the three-phase AC supply (e.g. to correct a power factor lead caused by the electromagnetic interference filter). For example, the duty cycle controller may be configured to vary (or the method may comprise varying) the duty cycles of the first and/or second transformers to thereby introduce a phase lag which cancels out a leading power factor introduced by the electromagnetic interference filter. It may be that electrical energy is transferred (or the method may comprise transferring electrical energy) between the first and second power rails (typically from the first power rail to the second power rail) to correct the leading power factor.

By “correcting” a power factor (e.g. lead), we mean adjusting the power factor to bring it closer to unity.

Typically the duty cycle controller is configured to vary (or the method may comprise varying) the duty cycles of the first and/or second transformers such that, for at least a portion of a phase cycle of the three phase supply, the first transformer outputs a greater amount of electrical energy than required by the DC output and a portion of the electrical energy (e.g. the excess electrical energy not consumed by the DC output) provided by the first transformer is fed back to the electromagnetic interference filter by way of the second transformer to thereby correct the said power factor. It can be said that, for the said portion of a phase cycle of the three-phase supply, the duty cycle of the second transformer is negative.

Typically the electrical energy fed back to the electromagnetic interference filter is fed back to and stored (or the method may comprise storing electrical energy fed back to the electromagnetic interference filter) by the capacitors of the electromagnetic interference filter. Typically the electrical energy stored by the capacitors of the electromagnetic interference filter is used (or the method may comprise using electrical energy stored by the said capacitors) later (e.g. within the said phase cycle) to supply electrical energy to the DC output.

Typically the control signals provided by the duty cycle controller to vary the duty cycles of the first and second transformers comprise one or more discontinuities (e.g. steps).

It may be that the duty cycle controller is configured to centrally nest (or the method may comprise centrally nesting) the duty cycles of the first and second transformers. This helps to optimise power factor correction.

It may be that the first and second transformers are coupled (or the method may comprise coupling the first and second transformers) to the respective first and second power rails by respective inverters, and it may be that the inverters each comprise a plurality of switches (e.g. field effect transistors). In this case, it may be that the duty cycle controller is configured to configure (or the method may comprise configuring) the duty cycles of the first and second transformers to ensure that the switches of the inverters perform zero voltage switching (“soft switching”). For example, where the duty cycles of both the first and second transformers are positive (i.e. where the duty cycles of the first and second transformers are configured such that the first and second power rails contribute to the DC output), it may be that the duty cycle controller is configured to provide (or the method may comprise providing) the rising edges of the positive duty cycles of the first and second transformers simultaneously (i.e. to “left justify” the rising edges of the positive duty cycles of the first and second transformers). Where the duty cycle of the first transformer is positive and the duty cycle of the second transformer is negative (i.e. where the duty cycles of the first and second transformers are configured such that the first power rail contributes to the DC output but the second power rail does not), it may be that the duty cycle controller is configured to provide (or the method may comprise providing) the falling edge of the duty cycle of the first transformer simultaneously with the rising edge of the duty cycle of the second transformer (i.e. to “right justify” the falling edge of the duty cycle of the first transformer with the rising edge of the duty cycle of the second transformer).

Typically the second selector comprises a plurality of bidirectional switches. Typically each of the said bidirectional switches is configurable to an “on” state in which electrical current can propagate through the switch in both of two opposite directions. Typically each of the said bidirectional switches of the second selector are configurable to an “off” state in which electrical current is blocked from propagating through the switch in both of two opposite directions.

It may be that the bidirectional switches comprise back to back field effect transistors (FETs).

It may be that the second selector comprises: a first bidirectional switch configured to control a connection between a first phase of the three-phase supply and the second power rail portion; a second bidirectional switch configured to control a connection between the first phase of the three-phase supply and the second return power rail portion; a third bidirectional switch configured to control a connection between a second phase of the three-phase supply and the second power rail portion; a fourth bidirectional switch configured to control a connection between the second phase of the three-phase supply and the second return power rail portion; a fifth bidirectional switch configured to control a connection between a third phase of the three-phase supply and the second power rail portion; and a sixth bidirectional switch configured to control a connection between the third phase of the three-phase supply and the second return power rail portion.

It may be that the controller is configured to control (or the method may comprise controlling) the said bidirectional switches of the second selector in phased relationship with the three phase AC supply to select the said different one of the highest, the second highest or the lowest instantaneous phase to phase voltages of the three-phase AC supply to provide the second power rail.

It will be understood that, because the switches of the second selector are bidirectional, electrical energy provided by the first power rail can be fed back to the electromagnetic interference filter (typically in the form of electrical current, typically to capacitors of the filter) through the said switches to correct the leading power factor caused thereby (see above).

Typically the power converter comprises a phase reference generator in communication with the duty cycle controller, the phase reference generator being configured to provide (or the method may comprise providing) the duty cycle controller with a phase angle reference indicative of the instantaneous phase of the three-phase AC supply. It may be that the duty cycle controller is configured to vary (or the method may comprise varying) the duty cycles of the first and second transformers taking into account (typically in dependence on) the phase angle reference.

Any suitable phase reference generator could be employed. Preferably the phase reference generator comprises a comparator configured to compare (or the method may comprise comparing) a first instantaneous phase voltage of the three-phase AC supply with a (different) second instantaneous phase voltage of the three-phase AC supply, and to generate (or the method may comprise generating) output events responsive to one of the said instantaneous phase voltages becoming equal to or greater than the other said instantaneous phase voltage during a phase cycle of the three-phase AC supply, the phase reference generator being configured to generate (or the method may comprise generating) a phase angle reference indicative of an instantaneous phase of the three-phase AC supply taking into account (typically in dependence on) the relative phases of the said output events. Typically the comparator outputs an event when either one of the first and second instantaneous phase voltages becomes greater than or equal to the other. That is, the comparator outputs an event when the first said instantaneous voltage becomes greater than or equal to the second, and the comparator outputs an event when the second said instantaneous voltage becomes greater than or equal to the first.

It will be understood that, typically, for each of the said one or more comparators, the first instantaneous phase voltage becomes equal to or greater than the second instantaneous phase voltage once per phase cycle of the three-phase supply. Similarly, the second instantaneous phase voltage becomes equal to or greater than first instantaneous phase voltage once per phase cycle of the three-phase supply. Accordingly, by generating output events when one of the said instantaneous phase voltages becomes equal to or greater than the other, two output events are generated per comparator per phase cycle of the three-phase AC supply (i.e. one when the first instantaneous phase voltage becomes greater than or equal to the second instantaneous phase voltage and one when the second instantaneous phase voltage becomes greater than or equal to the first instantaneous phase voltage).

Preferably the phase reference generator further comprises a second comparator configured to compare (or the method may comprise comparing) the first instantaneous phase voltage with a third instantaneous phase voltage of the three- phase AC supply and to generate output events when the first instantaneous phase voltage becomes equal to or greater than the third instantaneous phase voltage and when the third instantaneous phase voltage becomes equal to or greater than the first instantaneous phase voltage. Typically the second comparator outputs an event when either one of the third and first instantaneous phase voltages becomes greater than or equal to the other. That is, the comparator outputs an event when the third said instantaneous voltage becomes greater than or equal to the first, and the comparator outputs an event when the first said instantaneous voltage becomes greater than or equal to the third.

Preferably the phase reference generator comprises further comprises a third comparator configured to compare (or the method may comprise comparing) the second instantaneous phase voltage with a third instantaneous phase voltage of the three-phase AC supply and to generate output events when the second instantaneous phase voltage becomes equal to or greater than the third instantaneous phase voltage and when the third instantaneous phase voltage becomes equal to or greater than the second instantaneous phase voltage. Typically the comparator outputs an event when either one of the second and third instantaneous phase voltages becomes greater than or equal to the other. That is, the comparator outputs an event when the second said instantaneous voltage becomes greater than or equal to the third, and the comparator outputs an event when the third said instantaneous voltage becomes greater than or equal to the second.

By generating an output event when one instantaneous phase voltage becomes equal to or greater than another instantaneous phase voltage, we include the following possibilities: generating an output event as soon as one instantaneous phase voltage equals the other instantaneous phase voltage; generating an output event as soon as one instantaneous phase voltage exceeds the other instantaneous phase voltage; generating an output event as soon as one instantaneous phase voltage exceeds the other instantaneous phase voltage by a predetermined threshold amount.

The said output events may, for example, comprise rising edges and/or falling edges of a (e.g. voltage or current) output from the (or the respective) comparator.

Typically the comparator(s) is(are) provided in communication with (or the method may comprise coupling the comparator(s) to) a phase locked loop configured to generate the said phase angle reference indicative of an instantaneous phase of the three-phase AC supply taking into account (typically in dependence on) the relative phases of the said two or more output events. It may be that an (or a respective) edge detector is provided (or it may be that the method comprises providing an (or a respective) edge detector) between the (or each) comparator and the phase locked loop, the edge detector(s) being configured to detect the said output events and to provide the phase locked loop with a reference responsive to detection of an output event by the edge detector.

Preferably the phase locked loop is configured to receive (or the method may comprise the phase locked loop receiving) two output events from each of the first, second and third comparators (or from respective edge detectors coupled to the comparators) during a (typically each) phase cycle of the three-phase AC supply and the phase locked loop is configured to output (or the method may comprise the phase locked loop outputting) a phase angle reference which is determined taking into account (typically in dependence on) the (relative) phase of the said detected output events from the said first, second and third comparators.

The phase locked loop is typically configured to adjust (or the method may comprise the phase locked loop adjusting) the phase angle reference responsive to the relative phases of the said detected output events.

Typically the controller is configured to receive (or the method may comprise receiving) a phase angle reference indicative of the instantaneous phase of the three-phase AC supply from the phase reference generator. Typically the controller is configured to use (or the method may comprise using) the said phase angle reference to control the said bidirectional switches of the second selector in phased relationship with the three-phase AC supply to select the said different one of the highest, the second highest or the lowest instantaneous phase to phase voltages of the three-phase supply.

It may be that the first selector is configured to select (or the method may comprise selecting) the said one of the highest, the second highest or the lowest instantaneous phase to phase voltages of the three-phase supply to provide the first power rail taking into account the phase angle reference. It may be that the second selector is configured to select (or the method may comprise selecting) the said different one of the highest, the second highest or the lowest instantaneous phase to phase voltages of the three-phase supply to provide the second power rail taking into account the phase angle reference.

Typically the combiner comprises a (single) pair of secondary windings comprising a secondary winding of the first transformer connected in series with a secondary winding of the second transformer.

Typically the combiner comprises a rectifier coupled to the outputs (typically the secondary windings) of the first and second transformers. It may be that the method comprises rectifying the outputs of the first and second transformers.

Typically the combiner further comprises a low pass filter configured to receive (and low pass filter) an output from the rectifier and to provide the DC output. It may be that the method comprises low pass filtering an output from the rectifier to provide the DC output.

It may be that the power converter is a grid tied power converter.

It may be that the power converter is configurable to convert (or the method may comprise converting) a three-phase AC voltage supply to a DC voltage or DC current output in an AC to DC mode and to convert (and/or the method may comprise converting) electrical energy from a DC source (e.g. a battery or solar cell array) to a three-phase AC current output (e.g. to a three phase AC mains) in a DC to AC mode. That is, the power converter is typically a bi-directional power converter. This allows the converter to draw (or the method comprises drawing) in electrical power from the three-phase AC supply (e.g. from the grid) in the AC to DC mode (e.g. of the controller) to charge a DC power storage device (e.g. a battery), and in the DC to AC mode (e.g. of the controller) to discharge (or the method comprises discharging) electrical power from the DC power storage device back to the three-phase AC supply (e.g. to the grid). This makes the power converter suitable for renewable energy applications, particularly where the renewable energy source is unreliable, remote from users and/or has to store energy at off-peak times for use at peak times (e.g. wind, tidal or solar power).

Typically the first selector comprises a plurality of bidirectional switches. Typically each of the said bidirectional switches is configurable to an “on” state in which electrical current can propagate through the switch in both of two opposite directions. Typically each of the said bidirectional switches of the first selector are configurable to an “off” state in which electrical current is blocked from propagating through the switch in both of two opposite directions.

It may be that the bidirectional switches each comprise back to back field effect transistors (FETs).

It may be that the first selector comprises: a first bidirectional switch configured to control a connection between a first phase of the three-phase supply and the first power rail portion; a second bidirectional switch configured to control a connection between the first phase of the three-phase supply and a first return power rail portion; a third bidirectional switch configured to control a connection between a second phase of the three-phase supply and the first power rail portion; a fourth bidirectional switch configured to control a connection between the second phase of the three-phase supply and the first return power rail portion; a fifth bidirectional switch configured to control a connection between a third phase of the three-phase supply and the first power rail portion; and a sixth bidirectional switch configured to control a connection between the third phase of the three-phase supply and the first return power rail portion.

It may be that the controller is configured to control (or the method may comprise controlling) the said bidirectional switches of the first selector in phased relationship with the three phase AC supply to select the said one of the highest, the second highest or the lowest instantaneous phase to phase voltages of the three-phase supply (e.g. when in AC to DC mode).

Typically the controller is configured to receive (or the method may comprise receiving) a phase angle reference indicative of the instantaneous phase of the three-phase AC supply from the phase reference generator. Typically the controller is configured to use (or the method may comprise using) the said phase angle reference to control the said bidirectional switches in phased relationship with the three-phase AC supply to select the said one of the highest, the second highest or the lowest instantaneous phase to phase voltages of the three-phase supply.

Typically both the first and second selectors comprise bidirectional switches as set out above. In this way, when the power converter is configured in DC to AC mode, the bidirectional switches can be configured to permit electrical current to flow from the power converter back into the three-phase AC supply (as well as being configurable to permit electrical current to flow from the three-phase AC supply into the power converter when the power converter is configured in AC to DC mode).

It will be understood that, in embodiments where the power converter is a bidirectional power converter, the first and second inverters are typically configurable (e.g. by the controller) to operate in an inverting mode when the power converter is configured in the AC to DC mode and to operate in a rectifying mode when the power converter is configured in the DC to AC mode. For example, the first and second inverters may comprise H-bridges comprising bi-directional switches configurable in an “on” state in which electrical current can propagate through the switch in both of two opposite directions.

It will be understood that, in embodiments where the power converter is a bidirectional power converter, the rectifier of the combiner is configurable (e.g. by the controller) to operate in a rectifying mode when the power converter is configured in the AC to DC mode and to operate in an inverting mode when the power converter is configured in the DC to AC mode. The rectifier may comprise a plurality of bi-directional switches configurable to an “on” state in which electrical current can propagate through the switch in both of two opposite directions. For example, the rectifier may comprise an H-bridge comprising bi-directional switches (each of which may be provided by back-to-back FETs) configurable to an “on” state in which electrical current can propagate through the switch in both of two opposite directions. It may be that the bi-directional switches are configurable to an “off” state in which electrical current is inhibited (or blocked) from propagating in at least one direction through the respective switches.

Typically the rectifier comprises a plurality of bidirectional switches, each of the bidirectional switches being configurable to an “on” state in which it permits the flow of electrical current therethrough in both of two opposite directions. For example, the bidirectional switches of the rectifier may comprise field effect transistors (FETS). It will be understood that each of the bidirectional switches of the rectifier may be configurable to an “off” state in which it blocks the flow of electrical current therethrough in both of two opposite directions. However, it is typically sufficient for the bidirectional switches of the rectifier to be configurable to an “off” state in which it blocks the flow of electrical current therethrough in a single direction.

In the DC to AC mode, it may be that the rectifier of the combiner is configured to operate in an inverting mode such that it is configured to convert a DC input to AC by inverting the DC input. Typically the inverters (where provided) between the combiner and the first and second power rails are configured to operate in a rectifying mode to thereby rectify the AC signal from the primary windings of the transformers to provide the first and second power rails. Typically the rectifier(s) provided between the three-phase AC input and the inverters are configured to operate in an inverting mode to thereby provide a three-phase AC output current from the first and second power rails. Typically the said three-phase AC output current is fed to the grid.

A third aspect of the invention provides a phase reference generator for providing a phase angle reference indicative of the instantaneous phase of a three-phase alternating current (AC) supply, the phase reference generator comprising: a comparator configured to compare a first instantaneous phase voltage of the three-phase AC supply with a (different) second instantaneous phase voltage of the three-phase AC supply, and to generate output events responsive to one of the said instantaneous phase voltages becoming equal to or greater than the other said instantaneous phase voltage during a phase cycle of the three-phase AC supply, the phase reference generator being configured to generate a phase angle reference indicative of an instantaneous phase of the three-phase AC supply taking into account (typically in dependence on) the relative phases of the said output events.

Typically the comparator outputs an event when either one of the first and second instantaneous phase voltages becomes greater than or equal to the other. That is, the comparator outputs an event when the first said instantaneous voltage becomes greater than or equal to the second, and the comparator outputs an event when the second said instantaneous voltage becomes greater than or equal to the first.

It may be that the phase reference generator further comprises a second comparator configured to compare the first instantaneous phase voltage with a third instantaneous phase voltage of the three-phase AC supply and to generate output events when the first instantaneous phase voltage becomes equal to or greater than the third instantaneous phase voltage and when the third instantaneous phase voltage becomes equal to or greater than the first instantaneous phase voltage, wherein the phase reference generator is configured to generate the phase angle reference taking into account (typically in dependence on) the relative phases of the said output events. Typically the second comparator outputs an event when either one of the third and first instantaneous phase voltages becomes greater than or equal to the other. That is, the comparator outputs an event when the third said instantaneous voltage becomes greater than or equal to the first, and the comparator outputs an event when the first said instantaneous voltage becomes greater than or equal to the third.

It may be that the phase reference generator comprises a third comparator configured to compare the second instantaneous phase voltage with a or the third instantaneous phase voltage of the three-phase AC supply and to generate output events when the second instantaneous phase voltage becomes equal to or greater than the third instantaneous phase voltage and when the third instantaneous phase voltage becomes equal to or greater than the second instantaneous phase voltage, wherein the phase reference generator is configured to generate the phase angle reference taking into account (typically in dependence on) the relative phases of the said output events. Typically the comparator outputs an event when either one of the second and third instantaneous phase voltages becomes greater than or equal to the other. That is, the comparator outputs an event when the second said instantaneous voltage becomes greater than or equal to the third, and the comparator outputs an event when the third said instantaneous voltage becomes greater than or equal to the second.

By generating an output event when the first instantaneous phase voltage becomes equal to or greater than second instantaneous phase voltage, we include the following possibilities: generating an output event as soon as the first instantaneous phase voltage equals the second instantaneous phase voltage; generating an output event as soon as the first instantaneous phase voltage exceeds the second instantaneous phase voltage; generating an output event as soon as the first instantaneous phase voltage exceeds the second instantaneous phase voltage by a predetermined threshold amount.

The said output events may, for example, comprise rising edges and/or falling edges of a (e.g. voltage) output from the (or the respective) comparator. It may be that an (or a respective) edge detector is provided between the (or each) comparator and the phase locked loop, the edge detector(s) being configured to detect the said output events and to provide the phase locked loop with a reference responsive to detection of an output event by the edge detector.

It will be understood that, typically, for each of the said one or more comparators, the first instantaneous phase voltage becomes equal to or greater than the second instantaneous phase voltage once per phase cycle of the three-phase supply. Similarly, the second instantaneous phase voltage becomes equal to or greater than first instantaneous phase voltage once per phase cycle of the three-phase supply. Accordingly, by generating output events when one of the said instantaneous phase voltages becomes equal to or greater than the other, two output events are generated per comparator per phase cycle of the three-phase AC supply (i.e. one when the first instantaneous phase voltage becomes greater than or equal to the second instantaneous phase voltage and one when the second instantaneous phase voltage becomes greater than or equal to the first instantaneous phase voltage).

Preferably the phase locked loop is configured to receive two output events from each of the first, second and third comparators (or from respective edge detectors coupled to the comparators) during a (typically each) phase cycle of the three-phase AC supply and the phase locked loop is configured to output a phase angle reference which is determined taking into account the (relative) phase of the said detected output events from the said first, second and third comparators.

The phase locked loop is typically provided in communication with the comparator(s). The phase locked loop is typically configured to generate the said phase angle reference indicative of an instantaneous phase of the three-phase AC supply taking into account (typically in dependence on) the relative phases of the said output events (received from the comparators or from edge detectors provided between the comparators and the phase locked loop).

Typically the phase locked loop is configured to receive (e.g. two) output events from each of the first, second and third comparators (or from respective edge detectors) during a (typically each) phase cycle of the three-phase AC supply and the phase locked loop is configured to output a phase angle reference which is determined taking into account (typically in dependence on) the (relative) phases of the said detected output events from the said first, second and third comparators.

It may be that the phase locked loop is configured to adjust the phase angle reference responsive to the relative phases of the said detected output events.

A fourth aspect of the invention provides a method of providing a phase angle reference indicative of the instantaneous phase of a three-phase alternating current (AC) supply, the method comprising: comparing a first instantaneous phase voltage of the three-phase AC supply with a (different) second instantaneous phase voltage of the three-phase AC supply; generating output events responsive to one of the said instantaneous phase voltages becoming equal to or greater than the other said instantaneous phase voltage during a phase cycle of the three-phase AC supply; and generating a phase angle reference indicative of an instantaneous phase of the three-phase AC supply taking into account (typically in dependence on) the relative phases of the said output events.

The method may further comprise: comparing the first instantaneous phase voltage with a third instantaneous phase voltage of the three-phase AC supply; generating output events when the first instantaneous phase voltage becomes equal to or greater than the third instantaneous phase voltage and when the third instantaneous phase voltage becomes equal to or greater than the first instantaneous phase voltage; and generating the said phase angle reference taking into account (typically in dependence on) the relative phases of the said output events. The method may comprise: comparing the second instantaneous phase voltage with a or the third instantaneous phase voltage of the three-phase AC supply; generating output events when the second instantaneous phase voltage becomes equal to or greater than the third instantaneous phase voltage and when the third instantaneous phase voltage becomes equal to or greater than the second instantaneous phase voltage; and generating the said phase angle reference taking into account (typically in dependence on) the relative phases of the said output events.

The method may comprise generating the said phase angle reference taking into account (typically in dependence on) the relative phases of the said output events by way of a phase-locked loop.

It may be that the controller is configured to receive (e.g. six) said output events during a (typically each) phase cycle of the three-phase AC supply. Typically the phase-locked loop is configured to determine (and output) a phase angle reference taking into account (typically in dependence on) the (relative) phases of the said detected output events.

It may be that the phase locked loop is configured to adjust the phase angle reference responsive to the relative phases of the said detected output events.

The preferred and optional features discussed above are preferred and optional features of each aspect of the invention to which they are applicable.

### DESCRIPTION OF THE DRAWINGS

An example embodiment of the present invention will now be illustrated with reference to the following Figures in which:

FIG. 1 is a schematic circuit diagram of a three-phase AC to DC power converter;

FIG. 2a shows how the instantaneous phase voltages of an exemplary three-phase supply vary with line phase;

FIG. 2b illustrates timings applied to the three switches of the second selector of FIG. 1 over a phase cycle of the three-phase AC supply;

FIG. 2c illustrates the voltages of the first and second bulk power rails over a phase cycle of the three-phase AC supply;

FIG. 3a is a simplified schematic circuit diagram of the first inverter of the power converter of FIG. 1;

FIG. 3b is a timing diagram illustrating the operation of the inverter of FIG. 3a;

FIG. 4a is a circuit diagram showing the transformers of the power converter of FIG. 1 connected to rectification and low pass filtering circuitry;

FIG. 4b is a timing diagram illustrating the operation of the transformers of FIG. 4a and the load current through the inductor of the low pass filtering circuitry;

FIG. 5 is a schematic block diagram of an exemplary implementation of the controller of the power converter of FIG. 1;

FIG. 6 is a schematic circuit diagram of a phase cross-over detection circuitry of the controller of FIG. 5;

FIG. 7 is a waveform diagram illustrating the generation of output events by the comparators of FIG. 6 and the phase angle reference generated by the phase angle reference generator of FIG. 5 taking into account the output events;

FIGS. 8a-8d are waveform diagrams showing: in phase voltage and current waveforms from a first phase of the three-phase AC supply for a portion of a phase cycle of the three-phase AC supply (FIG. 8a); the first and second power rail voltages of the power converter of FIG. 1 for that portion of a phase cycle (FIG. 8b); duty cycle control signals for the first and second transformers of the power converter of FIG. 1 for that portion of the phase cycle (FIG. 8c); and voltage and current waveforms at the DC output for that portion of the phase cycle (FIG. 8d);

FIG. 9 is a circuit diagram of an electromagnetic interference filter provided at an input of the power converter;

FIGS. 10a-10d are waveform diagrams showing: phase voltage and current waveforms from a first phase of the three-phase AC supply for a portion of a phase cycle of the three-phase AC supply (FIG. 10a), the phase current leading the phase voltage due to a leading power factor; the first and second power rail voltages of the power converter of FIG. 1 for that portion of a phase cycle (FIG. 10b); duty cycle control signals for the first and second transformers of the power converter of FIG. 1 for that portion of the phase cycle (FIG. 10c); and voltage and current waveforms of the DC output for that portion of the phase cycle (FIG. 10d);

FIGS. 11a-11d are waveform diagrams showing: phase voltage and current waveforms from a first phase of the three-phase AC supply for a portion of a phase cycle of the three-phase AC supply (FIG. 11a), the phase voltage and the phase current being in phase due to power factor correction according to the present invention; the first and second power rail voltages of the power converter of FIG. 1 for that portion of a phase cycle (FIG. 11b); adjusted duty cycle control signals for the first and second transformers of the power converter of FIG. 1 for that portion of the phase cycle in order to correct the leading power factor observed in FIG. 10a (FIG. 11c); and voltage and current waveforms at the DC output for that portion of the phase cycle (FIG. 11d);

FIG. 12 is a schematic circuit diagram of an alternative three-phase AC to DC power converter to that shown in FIG. 1 which permits electrical energy to be supplied to the capacitors of the electromagnetic interference filter from the first bulk power rail via the second transformer, inverter and rectifier connected to the second power rail to correct a leading power factor;

FIG. 13 is a schematic circuit diagram of a bi-directional three-phase AC to DC power converter having a first, AC to DC mode in which it is operable to convert a three-phase AC supply to a DC output and a second, DC to AC mode in which it is operable in reverse to convert a DC input to a three-phase AC output; and

FIG. 14 is a schematic circuit diagram of a hold-up capacitor circuit connected to, and between, the first and second power rails (and their returns) via respective switches.

### DETAILED DESCRIPTION OF AN EXAMPLE EMBODIMENT

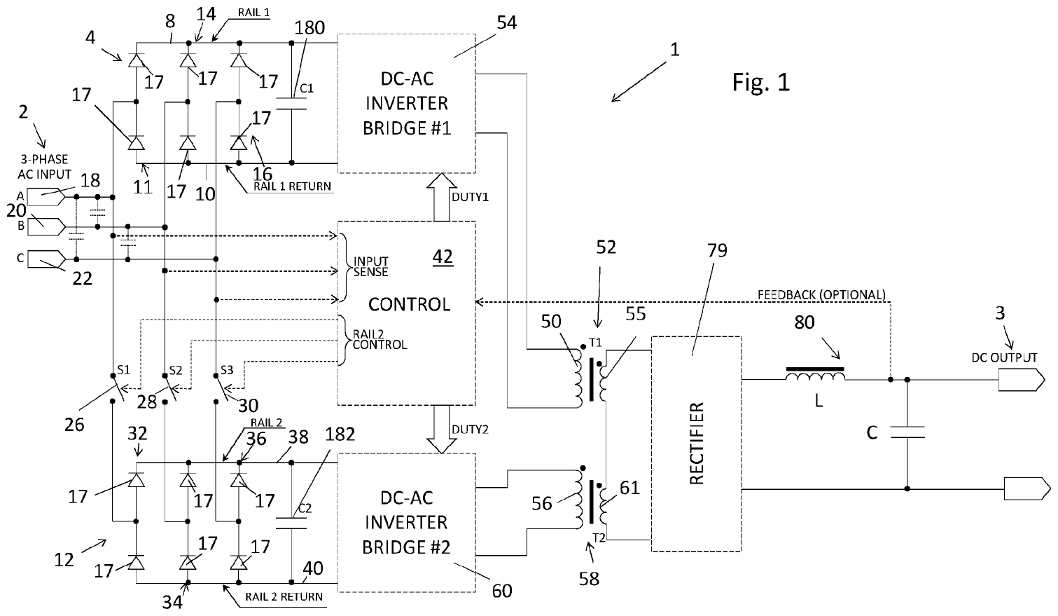

FIG. 1 is a schematic circuit diagram of a power converter 1 for converting a three-phase alternating current (AC) supply 2 to a DC output 3. The power converter 1 comprises a first selector 4 comprising a first three-phase diode bridge configured to select the highest instantaneous phase-to-phase voltage of the three-phase AC supply 2 between a first power rail portion 8 and a first return power rail portion 10 of a first power rail. The first three-phase diode bridge comprises the parallel combination of first, second and third circuit branches 11, 14, 16, each circuit branch 11, 14, 16 comprising two diodes 17 connected in series between the first power rail portion 8 and the first return power rail portion 10, both diodes 17 in each branch being connected in the same orientation (the cathode of a first diode in each branch being connected to the first power rail portion 8 and the anode of the first diode being connected to the cathode of a second diode of that branch, the anode of the second diode being connected to the return of the first power rail portion 8). A first phase 18 of the three-phase AC supply 2 is electrically connected to the anode of the first diode of the first circuit branch 11 and to the cathode of the second diode 17 of that branch; a second phase 20 of the three-phase AC supply 2 is electrically connected to the anode of the first diode 17 of the second circuit branch 14 and to the cathode of the second diode 17 of that branch 14; and a third phase 22 of the three-phase AC supply 2 is electrically connected to the anode of the first diode 17 of the third circuit branch 16 and to the cathode of the second diode 17 of that branch.

The power converter 1 further comprises a second selector 12 comprising a second three-phase diode rectifier bridge coupled to the three-phase AC supply 2 by way of first, second and third switches 26, 28, 30. The second three-phase diode rectifier bridge, together with the switches 26, 28, 30, is configured to select the second highest instantaneous phase-to-phase voltage from the three-phase AC supply between a second power rail portion 38 and a second return power rail portion 40 of a second power rail. The second three-phase diode rectifier bridge is identical to the first three-phase diode, with three circuit branches 32, 34, 36 (each comprising two series connected diodes 17 as discussed above) being connected together in parallel between the second power rail portion 38 and the second return power rail portion 40 (rather than between the first power rail portion 8 and the first return power rail portion 10). The first switch 26 is provided between the first phase 18 of the three-phase AC supply 2 and the anode of the first diode 17 and the cathode of the second diode 17 of the first circuit branch 32; the second switch 28 is provided between the second phase 20 of the three phase AC supply 2 and the anode of the first diode 17 and the cathode of the second diode 17 of the second circuit branch 34; and the third switch 30 is provided between the third phase 20 of the three phase AC supply 2 and the anode of the first diode 17 and the cathode of the second diode 17 of the third circuit branch 36.

The first, second and third switches 26, 28, 30 are independently switchable by a controller 42 between closed positions in which the respective first, second and third phases are connected to the first, second and third circuit branches 32, 34, 36 of the second diode bridge 24 respectively, and open positions in which the respective first, second and third phases are disconnected from the first, second and third circuit branches 32, 34, 36 of the second diode bridge respectively. The controller 42 is configured to open and close the switches 26, 28, 30 in phased relationship with the three-phase AC supply such that the second diode bridge selects the second highest instantaneous phase-to-phase voltage of the three-phase AC supply. For instantaneous phase voltages of the three-phase AC supply of:

Vₚₕₐₛₑ₁=√2Vᵣₘₛcos (ωt)

Vₚₕₐₛₑ₂=√2Vᵣₘₛcos(ωt+120°)

Vₚₕₐₛₑ₃=√2Vᵣₘₛcos(ωt+240°)

where Vᵣₘₛ is the line to neutral root-mean-square voltage of the three-phase supply and ωt is the line phase in degrees of the three-phase supply, the switch state for the first, second and third switches 26 (S1), 28 (S2), 30 (S3) are as follows:

S₁ₛₜₐₜₑ=mod(ωt+30°, 90°)<60°

S₂ₛₜₐₜₑ=mod(ωt+60°, 90°)<60°

S₃ₛₜₐₜₑ=mod(ωt, 90°)<60°

In this case, the voltages across the first and second bulk power rails (i.e. between the respective positive power rails 8, 38 and their returns 10, 40) will approximate to:

V_{RAIL1}(ωt)=max(|Vₚₕₐₛₑ₁(ωt)−Vₚₕₐₛₑ₂(ωt)|, |Vₚₕₐₛₑ₂(ωt)−Vₚₕₐₛₑ₃(ωt)|, |Vₚₕₐₛₑ₃(ωt)−V_{phase 1}(ωt)|)

V′ₚₕₐₛₑ₁=Vₚₕₐₛₑ₁(ωt)S₁ₛₜₐₜₑ(ωt)

V′ₚₕₐₛₑ₂=Vₚₕₐₛₑ₂(ωt)S₂ₛₜₐₜₑ(ωt)

V′ₚₕₐₛₑ₃=Vₚₕₐₛₑ₃(ωt)S₃ₛₜₐₜₑ(ωt)

V_{RAIL2}(ωt)=max(|Vₚₕₐₛₑ₁(ωt)−Vₚₕₐₛₑ₂(ωt)|, |Vₚₕₐₛₑ₂(ωt)−Vₚₕₐₛₑ₃(ωt)|, |Vₚₕₐₛₑ₃(ωt)−V_{phase 1}(ωt)|)

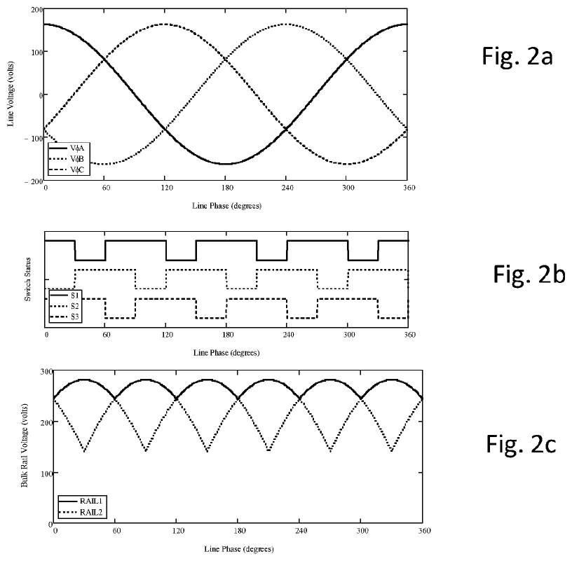

The instantaneous voltages of the first, second and third phases 18, 20, 22 of the three-phase AC supply are illustrated in FIG. 2a, with switch timings for switches 26 25 (S1), 28 (S2), 30 (S3) being illustrated in FIG. 2b. The first and second bulk power rail voltages 8, 38 are illustrated in FIG. 2c (for a phase cycle of the three-phase AC supply). In FIG. 2a, VφA is Vₚₕₐₛₑ₁, VφB is Vₚₕₐₛₑ₂ and VφC is Vₚₕₐₛₑ₃.

The first power rail portion 8 and the first return power rail portion 10 are selectively coupled to a primary winding 50 of a first step-down transformer 52 by way of a first DC to AC inverter bridge 54. The first transformer 52 further comprises a secondary winding 55 magnetically coupled to the primary winding 50. The second power rail portion 38 and the second return power rail portion 40 are selectively coupled to a primary winding 56 of a second step-down transformer 58 by way of a second DC to AC inverter bridge 60. The second transformer 58 further comprises a secondary winding 61 magnetically coupled to the primary winding 56. The inverters 54, 60 act to convert the predominantly DC voltages across the respective first and second power rails (which also comprise an AC content at a (low) frequency related to the frequency of the three-phase AC supply, e.g. 50 Hz or 400 Hz) to predominantly high frequency (e.g. at least 1 kHz, at least 10 kHz or at least 100 kHz) AC voltages. By converting the predominantly DC voltages of the first and second power rails to higher frequency voltages, the physical sizes of the transformers 52, 58 (in particular the physical sizes of their cores) can be significantly reduced, thereby significantly decreasing the size and cost of the power converter 1.

The first and second inverter bridges 54, 60 are similar, so only the first inverter bridge 54 will be described in detail. However, it will be understood that the second inverter bridge 60 has similar features to the first inverter bridge 54.

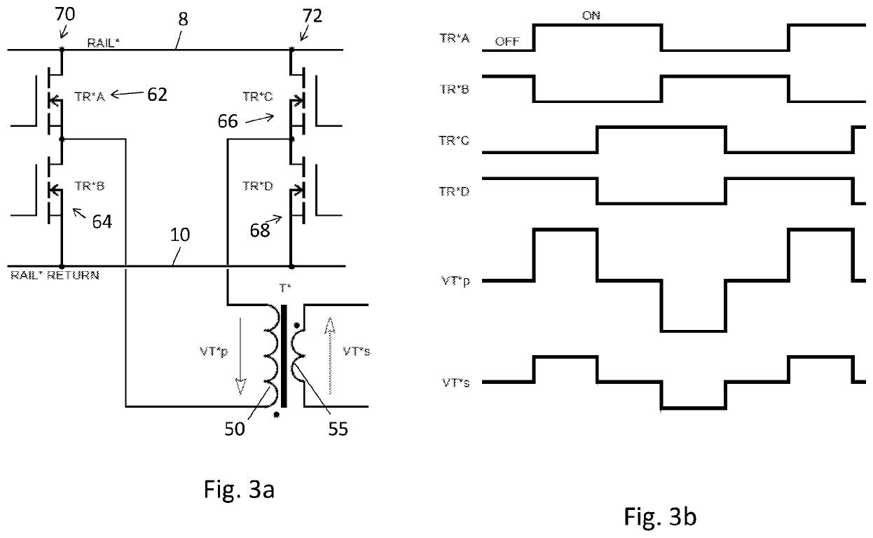

As shown in FIG. 3a, the first inverter bridge comprises an H-bridge circuit comprising four switches, in this case n-channel field effect transistors (FETs) 62, 64, 66, 68, connected between the first power rail portion 8 and the first return power rail portion 10 (although it will be understood that other types of switch may be used in place of the FETs, such as insulated-gate bipolar transistors (IGBT) with anti-parallel diodes or Gallium Nitride (GaN) or Silicon Carbide (SiC) switches). The first and second FETs 62, 64 are connected in series with each other between the first power rail portion 8 and the first return power rail portion 10 in a first circuit branch 70 (the drain of the first FET 62 being connected to the first bulk power rail 8, the source of the first FET 62 being connected to the drain of the second FET 64 and the source of the second FET 64 being connected to the return 10 of the first bulk power rail), and the third and fourth FETs 66, 68 are connected in series with each other between the first power rail portion 8 and the first return power rail portion 10 in a second circuit branch 72 in parallel with the first circuit branch 70 (the drain of the third FET 66 being connected to the first power rail portion 8, the source of the third FET 66 being connected to the drain of the fourth FET 68 and the source of the fourth FET 68 being connected to the return 10 of the first power rail portion 8). The source of the first FET 62 and the drain of the second FET 64 are (electrically) connected to a first (dot) end of the primary winding 50 of the first transformer 52 and the source of the third FET 66 and the drain of the fourth FET 68 are (electrically) connected to a second (non-dot) end of the primary winding opposite the first end.

The gate terminals of the FETs 62-68 are in communication with the controller 42, which is configured to apply a voltage to the gate terminals to control whether the FETs 62-68 are in their conducting (“on”) states or their non-conducting (“off”) states.

The controller 42 is also configured to control the timings at which the FETs 62-68 are turned on and off.

As illustrated in FIG. 3b (where “TR*A ON” represents a voltage being applied between the gate and source terminals of the first FET 62 which is greater than or equal to the threshold voltage thereby causing the first FET 62 to be switched on, “TR*A OFF” represents a voltage being applied across the gate and source terminals of the first FET 62 of less than the threshold voltage to thereby cause the first FET 62 to be switched off, and similarly for the other FETs TR*B, TR*C, TR*D which correspond to FETs 64, 66 and 68 respectively), when the first FET 62 is on and the second FET 64 is off, the first end (the dot end) of the primary winding 50 of the first transformer 52 is connected to the first power rail portion 8. When the first FET 62 is off and the second FET 64 is on, the first end (the dot end) of the primary winding 50 of the first transformer is connected to the first return power rail portion 10. Similarly, when the third FET 66 is on and the fourth FET 68 is off, the second end (the non-dot end) of the primary winding 50 of the first transformer 52 is connected to the first power rail portion 8. When the third FET 66 is off and the fourth FET 68 is on, the second end (the non-dot end) of the primary winding 50 of the first transformer is connected to the first return power rail portion 10.

FIG. 3b is a timing diagram illustrating one and a half phase cycles of the first inverter bridge (which is typically much shorter than a phase cycle of the three phase supply). Initially, the first FET 62 is off and the second FET 64 is on. Accordingly, the voltage at the first (dot) end of the primary winding of the first transformer 52 is equal to the voltage of the first return power rail portion 10. At this stage, the third FET is off and the fourth FET is on. Accordingly, the voltage at the second end of the primary winding of the first transformer 52 is also equal to the voltage of the first return power rail portion 10. Accordingly, the voltages across the primary and secondary windings of the first transformer 52 are zero. After a period of time (corresponding to 90° of a 360° phase cycle of the first inverter bridge), the first FET 62 is switched on and the second FET 64 is switched off. This causes the first (dot) end of the primary winding to be connected to the first power rail portion 8. The third and fourth FETs 66, 68 remain off and on respectively. Accordingly, a positive voltage appears across the primary and secondary windings 50, 55 (albeit the voltage across the secondary winding 55 is half the voltage across the primary winding 50 because the turns ratio of the primary transformer 52 in this example is Np:Ns=4:2). After a further period of time (corresponding to 90° of a 360° phase cycle of the first inverter bridge), the third FET 66 is switched on and the fourth FET 68 is switched off. This causes the second end of the primary winding to be connected to the first power rail portion 8. The first and second FETs 62, 64 remain on and off respectively. Accordingly, the voltage across the primary and secondary windings 50, 55 reverts to zero. After a further period of time (corresponding to 90° of a 360° phase cycle of the first inverter bridge), the first FET 62 is switched off and the second FET 64 is switched on. This causes the first (dot) end of the primary winding 50 to be connected to the first return power rail portion 10. The third and fourth FETs 66, 68 remain on and off respectively. Accordingly, the voltage across the primary winding 50 is the negative of the voltage across the first power rail (and the voltage across the secondary winding 55 is half of this). This cycle then repeats to generate the AC waveform output by the first inverter bridge.

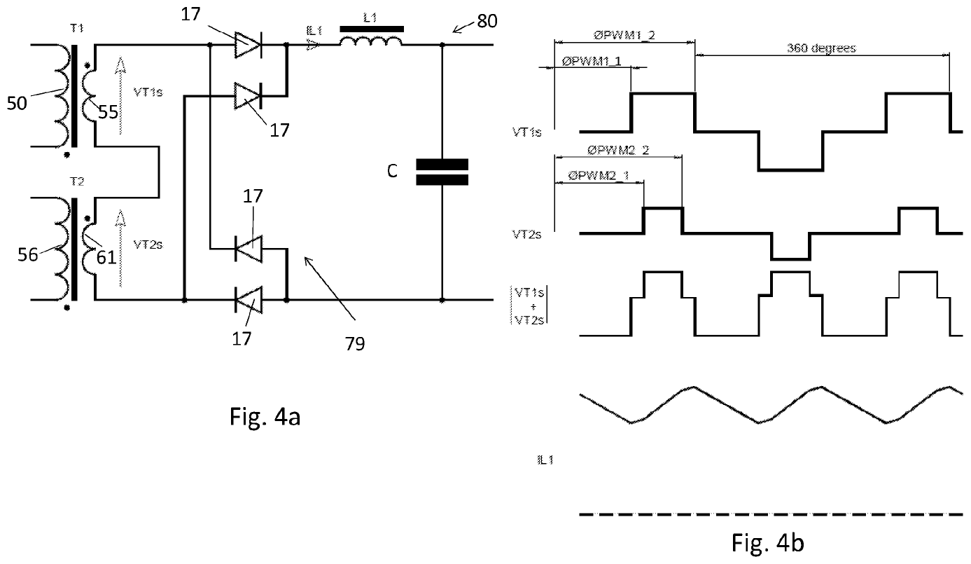

As shown in FIGS. 1 and 4a, the voltage and current outputs from the secondary windings 55, 61 of the first and second transformers 52, 60 are combined before being rectified by a rectifier 79 and low pass filtered by an LC low pass filter 80 to provide the DC output 3. The outputs from the secondary windings 55, 61 of the first and second transformers 52, 61 are combined by way of a series electrical connection. As the secondary windings 55, 61 are in series with each other, the electrical currents flowing through them must be equal. In the example of FIG. 4a, the rectifier is implemented as a diode bridge rectifier comprising four diodes 17. A first diode 17 is connected between the dot end of the secondary winding 55 of the first transformer 52 and an inductor L1 of the LC low pass filter (the anode being connected to the secondary winding and the cathode being connected to the inductor). A second diode 17 is connected between the inductor L1 and the non-dot end of the secondary winding 61 of the second transformer 58 (the anode being connected to the secondary winding 61 and the cathode being connected to the inductor L1). A third diode 17 is connected between the capacitor C of the LC filter and the non-dot end of the secondary winding 61 of the second transformer 58 (the anode being connected to the capacitor C and the cathode being connected to the secondary winding 61). A fourth diode 17 is connected between the anode of the third diodes 17 and the anode of the first diodes 17 (the anode of the fourth diode 17 being connected to the anode of the third diode 17 and the cathode of the fourth diode 17 being connected to the anode of the first diode).

FIG. 4b provides exemplary waveforms illustrating over one and a half phase cycles of the inverters 54, 60: the voltage across the secondary winding 55 of the first transformer 52 (top waveform); the voltage across the secondary winding 61 of the second transformer (second top waveform); the combined rectified voltages of the secondary windings 55, 61 of the first and second transformers 52, 58 (third top waveform); the DC voltage output from the low pass filter 80 (fourth top waveform); and the current through the inductor L1 (bottom waveform).

From a comparison of the voltage across the secondary winding 55 of the first transformer 52 (top waveform) and the voltage across the secondary winding 61 of the second transformer (second top waveform), it can be seen that a non-zero voltage appears across the secondary winding 61 of the second transformer 58 for less time than a non-zero voltage appears across the secondary winding 55 of the first transformer 52 over a phase cycle of the first and second inverters 54, 60. This is because the second transformer 58 has been provided with a lower duty cycle that the first transformer 52 by the controller 42. The duty cycle of the first transformer 52 can be defined as the percentage of a phase cycle of the first inverter 54 for which the first transformer 52 is active (i.e. the percentage of a phase cycle for which a non-zero voltage is applied across the primary winding 50). The duty cycle of the first transformer 52 may be defined as:

Duty1=(φ_{PWM1_2}−φ_{PWM1_1})/180°

where φ_{PWM1_1} is the period of time from the beginning of a phase cycle until the rising edge occurs when the voltage across the primary winding of the first transformer 52 goes high (corresponding to when the first FET 62 is closed and the second FET 64 is opened) and φ_{PWM1_2} is the period of time from the beginning of a phase cycle until the falling edge which occurs when the voltage across the primary winding of the first transformer 52 reverts to zero.

Similarly, the duty cycle of the second transformer 58 can be defined as the percentage of a phase cycle of the second inverter 60 for which the second transformer 58 is active (i.e. the percentage of a phase cycle for which a non-zero voltage is applied across the primary winding 56 of the second transformer 58). Using similar notation to that provided above, the duty cycle of the second transformer can be defined as:

Duty2=(φ_{PWM2_2}−φ_{PWM2_1})/180

where φ_{PWM2_1} is the period of time from the beginning of a phase cycle until a rising edge occurs when the voltage across the primary winding of the second transformer 58 goes high and φ_{PWM2_2} is the period of time from the beginning of a phase cycle until the falling edge which occurs when the voltage across the primary winding of the second transformer 58 reverts to zero.

In prior art power converters (such as the one described in EP2067246), the duty cycles of the first and second transformers are fixed and equal.

When the duty cycles of the first and second transformers are fixed and equal (as is the case in EP2067246), the currents drawn from the primary windings 50, 56 (and thus the secondary windings 55, 61) of the first and second transformers 52, 58 to provide the DC output are determined by the turns ratios (Ns:Np) of the first and second transformers 52, 58 (which are illustrated in FIG. 1 as being equal, but need not be). The average voltage across the DC output is also determined by the turns ratios of the first and second transformers 52, 58. Accordingly, the turns ratios of the first and second transformers are typically carefully chosen to optimise the power factor.

For an ideal power factor, the current flowing into or out of one of the three phases of the three-phase AC supply should be proportional to the sum of instantaneous voltages between the said phase and the two other phases. In addition, the ratio of the magnitude of the current drawn (e.g. by the DC output) from the second power rail to the magnitude of the current drawn (e.g. by the DC output) from the first power rail should be equal to the ratio of the sine of the instantaneous line phase angle to the sine of a compensated instantaneous line phase angle, the compensated instantaneous line phase angle being the instantaneous phase angle compensated for a phase difference between the phase voltage of the second power rail not in common with the first power rail and the phase voltage of the first power rail not in common with the second power rail (by adding a leading phase difference between them or subtracting a lagging phase difference between them). For example, at 0°, the first power rail is provided by the phase to phase voltage between the first and third phases 18, 22 and the second power rail is provided by the phase to phase voltage between the first and second phases 18, 20. The sine of the instantaneous phase angle (0°) is equal to 0, while the sine of the compensated instantaneous phase angle (0°+120°=120°) is equal to 0.866, the said ratio being 0. Accordingly, the current drawn from the second power rail should be 0 A. At 15°, the ratio is (sine(15°)/sine(135°)=)0.366. Therefore, the current drawn from the second power rail should be 0.366 times that drawn from the first power rail. At a phase angle of 30°, the current drawn from the second power rail should be equal to that drawn from the first power rail and so on.

As shown in FIG. 2c, during a phase cycle of the three-phase AC supply the voltages across both the first bulk power rail 8, 10 and the second bulk power rail 38, 40 rise and fall six times, with mirror symmetry about the peaks and troughs. Accordingly, other than at the peaks and troughs, specific ideal ratios of the current drawn from the first power rail 8, 10 to the current drawn from the second power rail 11 38, 40 are each repeated twelve times for each AC cycle. Between those twelve design points, the currents drawn from the first and second bulk power rails 8, 10 and 13 38, 40 (and thus from the first, second and third phases of the three-phase supply) are constrained to the design currents, leading to a stepped load profile. This in turn increases the harmonic content of the phase currents and increases the voltage ripple on the output DC voltage. In EP2067246, additional pairs of secondary windings having different numbers of turns may be connected in parallel with the series combination of the secondary windings 55, 61. Although this alleviates the constraints on the currents drawn from the first and second bulk power rails 8, 38 to an extent, thereby reducing the harmonic content of the phase currents and output voltage ripple, the addition of secondary winding pairs increases the cost and size of the power converter. There is also a practical limit to the benefit that can be achieved by this approach (e.g. a maximum of 3 or 4 additional pairs of secondary windings can realistically be added).

The inventor has realised that the relative contributions of the first and second transformers 52, 58 to the DC output (and thus the currents drawn from the first and second bulk power rails 8, 10 and 38, 40) can be adjusted by varying the duty cycles of the first and second transformers 52, 58. This is achieved, in the present exemplary embodiment, by the controller 42 adjusting the timings of the switching on and off of the FETs of the first and second inverter bridges 54, 60 through which the first and second bulk power rails 8, 10 and 38, 40 are coupled to the first and second transformers 52, 58. The duty cycles of the first and second transformers can thus be varied with a much finer granularity by the controller 42 (e.g. the duty cycles of the first and second transformers 52, 58 may be adjusted once per magnetic cycle of the first and second transformers respectively). Accordingly, the currents drawn from the first and second bulk power rails 8, 38 can be selected in the ideal ratio for each magnetic cycle of the first and second transformers 52, 58 (i.e. for more than 12 discrete values of line phase per phase cycle of the three phase AC supply without requiring additional pairs of transformers).

To achieve minimum output voltage ripple and minimum line current harmonic content of the three phases of the three phase supply, the duty ratios as a function of the line phase are given by the following expressions, Duty1 being the duty cycle of the first transformer 52 and Duty2 being the duty cycle of the second transformer 58:

Duty1=Ksin(60°−|30°−mod(ωt, 60°)|−φ)

Duty2=Ksin(|30°−mod(ωt, 60°)|−φ) N_{T2p}/N_{T2s}, N_{T1s}/N_{T1p}

where N_{T1p} is the number of turns in the primary winding 50 of the first transformer 52
N_{T1S} is the number of turns in the secondary winding 55 of the first transformer
N_{T2p} is the number of turns in the primary winding 56 of the second transformer 58
N_{T2s} is the number of turns in the secondary winding 61 of the second N_{T2S} transformer 58
K is a constant (or in some cases a slowly varying) term provided by a feedback network (where provided) from the DC output to the controller 42
φ is phase shift compensation.

It will be understood that the feedback provided from the DC output to the controller 42 is optional.

Other useful relations are as follows:

K=K₁δ_{T} (where K₁ is the gain factor for Duty 1)

where δ_{T} is the sum of Duty 1 and Duty 2 and, where the input voltages of the three phase supply and the output load are constant, δ_{T} can be treated as a constant.

K₂=K₁N_{T2p}/N_{T2s}, N_{T1s}/N_{T1p} (where K₂ is the gain factor for Duty 2)

K₁, K₂ and K can be derived from the knowledge that only the first power rail contributes to the output when ωt=30° (assuming φ=0):

Duty1=Ksin(60°)

δ_{T}=K₁δ_{T}sin)(60°)

K₁=1/sin(60°)=b 1.155

K₂=K₁N_{T2p}/N_{T2s}, N_{T1s}/N_{T1p}

K=₁Kδ_{T}

In an example where N_{T1p}=16, N_{T1s}=10, N_{T2P}=13, N_{T2S}=6 and δ_{T}=0.643, K=0.743 and K₂=1.56.

Neglecting losses (such as the forward voltage of the rectifier diodes), the voltage across the DC output will be given by:

$${V}_{outDC} = K √ 6 \frac{{N}_{T 1 S}}{{N}_{T 1 p}} {Vin}_{rms} [ Duty 1 \frac{NT 1 S}{NT 1 P} + Duty 2 \frac{NT 2 S}{NT 2 P} ]$$

where Vinᵣₘₛ is the root mean squared voltage of one of the phases of the three phase AC supply.

The duty cycles of the first and second transformers 52, 58 are typically different from each other for at least a portion (typically for the majority of) a phase cycle of the three-phase AC supply.

To ensure that the average currents in the first and second inverters 54, 60, and therefore the current drawn from the first and second bulk power rails 8, 10 and 38, 40 respectively, are proportional to the duty cycles of the first and second transformers 52, 58, the active drive periods of the first and second transformers are centrally nested, that is:

φ_{PWM1_2}+φ_{PWM1_1}=φ_{PWM2_2}+φ_{PWM2_1}

This is illustrated in FIG. 4b by the fact that the rectified voltage pulses provided by the secondary winding 61 of the second transformer 58 are superimposed on the centres of the corresponding rectified voltage pulses output by the secondary winding 55 of the first transformer 52.

This can be implemented as:

$$If Duty 1 \geq Duty 2 : \\ {φ}_{PWM 1 \_ 1} = 0 ° \\ {φ}_{PWM 1 \_ 2} = 180 ° Duty 1 \\ {φ}_{PWM 2 \_ 1} = 180 ° \frac{Duty 1 - Duty 2}{2} \\ {φ}_{PWM 2 \_ 2} = 180 ° \frac{Duty 1 + Duty 2}{2} \\ If Duty 1 < Duty 2 : \\ {φ}_{PWM 1 \_ 1} = 180 ° \frac{Duty 2 - Duty 1}{2} \\ {φ}_{PWM 1 \_ 2} = 180 ° \frac{Duty 1 + Duty 2}{2} \\ {φ}_{PWM 2 \_ 1} = 0 ° \\ {φ}_{PWM 2 \_ 2} = 180 ° Duty 2$$

For optimum reduction in line current harmonic content of the three phases of the three phase AC supply, the power converter should operate in continuous conduction mode, i.e. the current in the filter inductor L1 remains greater than 0 A at all times when the power converter is in use.

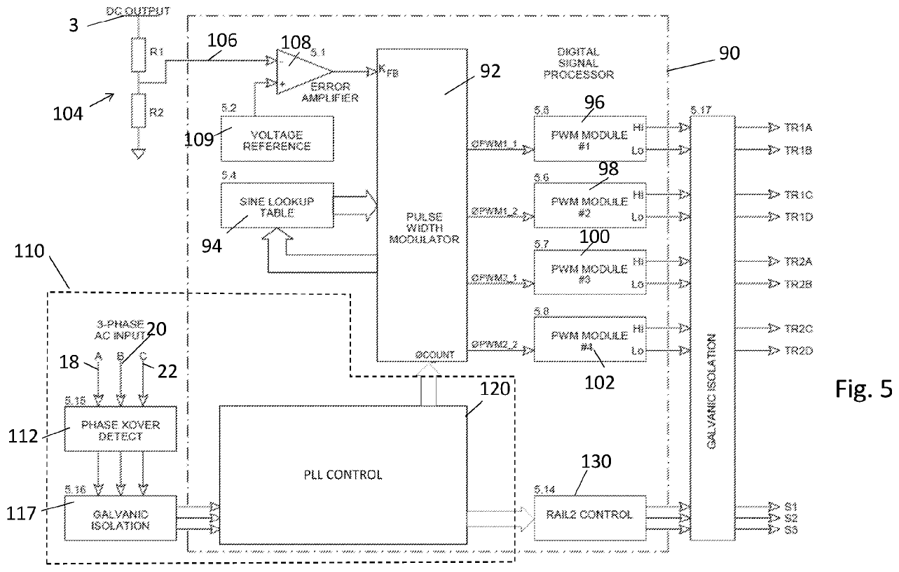

The required drive waveforms for electronic switches S1, S2, S3 and the FETs of the first and second inverters 54, 60 are typically derived by the controller 42, which may for example comprise a digital signal processing integrated circuit. There are numerous devices which are optimised for switched mode power supply control which would be suitable, such as a Microchip Technology Inc. dsPIC33FJ32GS406. An exemplary implementation of the controller 42 is illustrated in FIG. 5, and described below.

In the exemplary embodiment of FIG. 5 the controller 42 comprises a digital signal processor 90 comprising a pulse width modulator 92 configured to request and receive an input from a sine-wave lookup table 94 and to provide outputs to first, second, third and fourth pulse width modulation (PWM) modules 96, 98, 100, 102. The first PWM module 96 is coupled to the gate terminals of the first and second FETs 62, 64 of the first inverter 54 and the second PWM module 98 is coupled to the third and fourth FETs 66, 68 of the first inverter to thereby control φ_{PWM1_1} and φ_{PWM1_2} based on signals provided by the pulse width modulator 92 (which are based, in turn, on signals received from the sine-wave look up table 94). Similarly, the third PWM module 100 is coupled to the gate terminals of the first and second FETs of the second inverter 60 and the fourth PWM module 102 is coupled to the gate terminals of the third and fourth FETs of the second inverter to control φ_{PWM2_1} and φ_{PWM2_2} based on signals provided by the pulse width modulator 92 (which are based, in turn, on signals received from the sine-wave look up table 94). The pulse width modulator 92therefore controls the duty cycles Duty1 and Duty2 of the first and second transformers 52, 58 by way of the sine look up table 94, the PWM modules 96-102 and the first and second inverters 54, 60.

The pulse width modulator 92 is configured to receive feedback from the DC output 3 by way of a feedback network 104. In this case the feedback network 104 comprises a voltage divider comprising first and second resistors R1 and R2 connected in series with one another between the DC output 3 and ground. Line 106 extends from between R1 and R2 of the voltage divider to an inverting input of an operational amplifier 108, and a voltage reference 109 is provided to the non-inverting input of the operational amplifier 108. The voltage reference 109 is the desired DC output scaled down by a factor of R₂/(R₁+R₂). The amplifier 108 will act to force the voltage between R1 and R2 to a value equal to the voltage reference 109, to thereby generate a DC output 3 in accordance with the desired DC output by way of line 106. This section of the controller 42 thus provides a DC output voltage control loop. The output of the operational amplifier 108 provides the pulse width modulator 92 with the constant or slowly varying term K discussed above.

The pulse width modulator 92 is also configured to receive a phase angle reference from a phase reference generator 110. The phase angle reference provided by the phase reference generator is indicative of the instantaneous phase of the three-phase AC supply at any given time. The phase angle reference is fed to and used by the pulse width modulator 92 together with the signals from the sine-wave look up table 94 (and optionally the feedback signal from the DC output) to control the timings of the signals applied to the FETs of the first and second inverters by way of the PWM modules 96-102 to thereby control the duty cycles of the first and second transformers 52, 58.

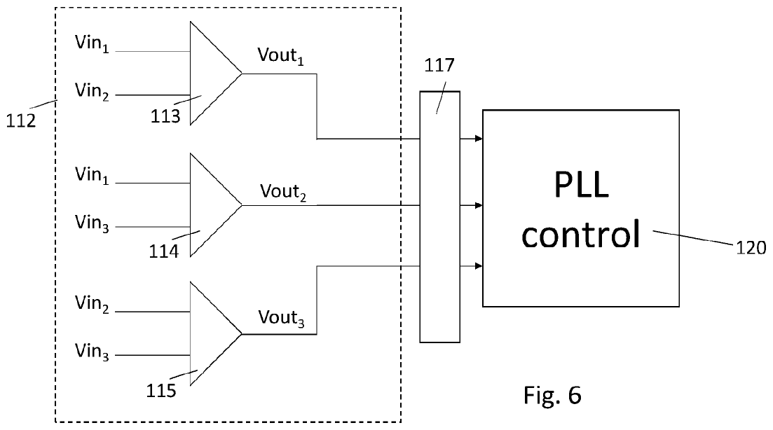

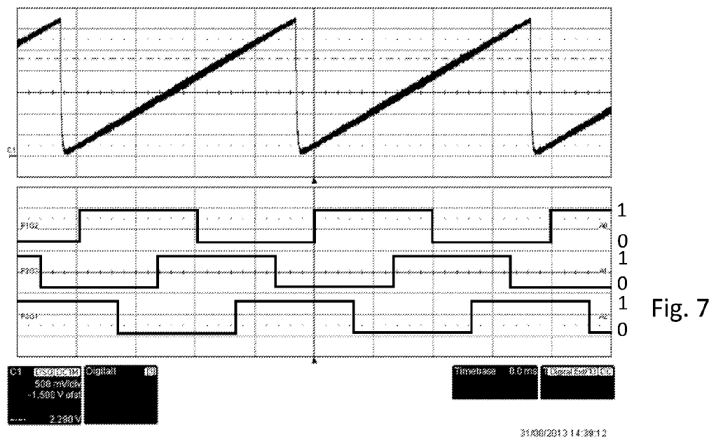

The phase angle reference generator 110 comprises a phase cross-over detect module 112, which may be implemented by way of computer program instructions executed by the digital signal processor or by hardware circuitry external to the digital signal processor, configured to receive instantaneous voltages of each of the three phases 18, 20, 22 of the three-phase AC supply as inputs and to determine cross-over points when one of the phases 18, 20, 22 becomes greater than or equal to another within a phase cycle of the three phase AC supply. As illustrated in FIG. 2a, this occurs six times per phase cycle of the three-phase supply, and the phase interval between cross-over points is 60° (for an ideal three-phase AC supply 2). An exemplary phase cross-over detect module 112 is illustrated in more detail in FIG. 6. In this case the phase cross-over detect module 112 comprises first, second and third comparators 113, 114, 115: the first comparator 113 being configured to compare the instantaneous voltages of the first and second phases 18, 20; the second comparator 114 being configured to compare the instantaneous voltages of the first and third phases 18, 22; and the third comparator 115 being configured to compare the instantaneous voltages of the second and third phases 20, 22. The comparators 113-115 each output a positive voltage when the instantaneous voltage of a first one of the phase inputs becomes greater than or equal to the other of the phase inputs, thereby outputting a rising edge, and a zero voltage when the instantaneous voltage of the said other of the phase inputs becomes greater than or equal to the first one of the said phase inputs, thereby outputting a falling edge. This is shown in FIG. 7, the top waveform showing an analogue representation of a digital phase angle count provided by a phase angle counter of the phase locked loop (PLL) control module 120 of the controller 42 representing line phase over two complete phase cycles of the three-phase AC supply (although it will be understood that the phase angle count is virtual in practice), and the bottom three waveforms of which correspond to the outputs from the comparators 113-115 during the said two complete phase cycles of the three-phase AC supply. The first (top) of these waveforms shows the output of comparator 113, which is high (digital output ‘1’) when the instantaneous voltage of phase 1 is greater than the instantaneous voltage of phase 2 and low (digital output ‘0’) when the instantaneous voltage of phase 2 is greater than the instantaneous voltage of phase 1. The second (middle) of these waveforms shows the output of comparator 114, which is high when the instantaneous voltage of phase 2 is greater than the instantaneous voltage of phase 3 and low when the instantaneous voltage of phase 3 is greater than the instantaneous voltage of phase 2. The third (bottom) of these waveforms shows the output of comparator 115, which is high when the instantaneous voltage of phase 3 is greater than the instantaneous voltage of phase 1 and low when the instantaneous voltage of phase 1 is greater than the instantaneous voltage of phase 3.

The rising and falling edges of the outputs of the comparators 113-115 can be considered as output events generated by the phase cross-over detect module 112. These output events are detected (e.g. by respective edge detectors) and fed to the PLL control module 120, the PLL control module 120 being galvanically isolated from the phase cross-over detection module 112 by a galvanic isolation module 117. The PLL control module 120 generates a repeating sawtooth waveform, the lowest amplitude of which indicates a 0° phase angle and the maximum amplitude of which indicates a 360° phase angle of the 3-phase AC supply. A counter within the digital signal processor 90 counts from 0 to 2″, each count of which digitally represents a phase angle value. N is the number of bits used in the counter. The count 0 to 2″ repeats each time a count of 2″ is reached.

Over time, the sawtooth waveform generated by the counter is adjusted by the PLL control module 120 taking into account the relative phases of the detected cross-over points (which are of known phase). This ensures that the phase angle reference stays in phase with the three-phase AC supply 2. The six output events of known phase detected within each phase cycle of the three-phase supply provide the phase locked loop with accurate reference information which helps to ensure the accuracy of the phase angle reference. The accuracy of the phase angle reference is particularly important for ensuring that the pulse width modulator 92 and PWM modules 96-102 control the duty cycles of the first and second transformers 52, 58 accurately.

As illustrated in FIG. 5, the phase angle reference output by the PLL control module 120 is also used by a control module 130 which is configured to open and close switches 26, 28, 30 to ensure that the second selector 112 selects the second highest instantaneous phase-to-phase voltage at any given time.

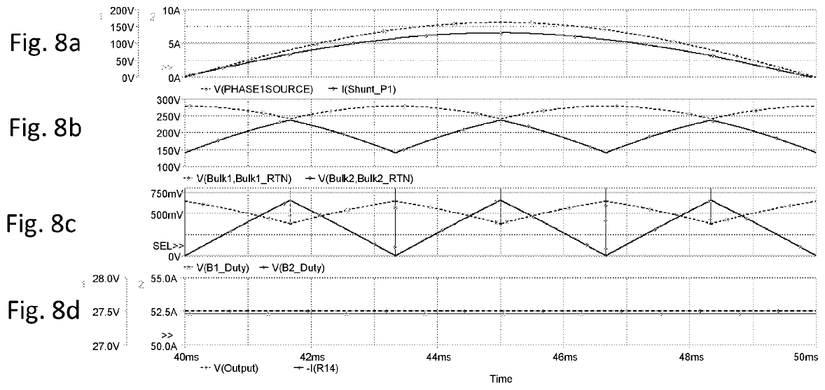

FIG. 8a illustrates the instantaneous voltage and current of the first input phase 18 of the three-phase AC supply over half of a phase cycle of the three-phase AC supply 2 (which in this case comprises a line to line voltage of 200V at 50 Hz) at 100% load. These plots assume a unity power factor as the phase current and phase voltage are in phase with each other. FIG. 8b illustrates the instantaneous voltages across the first and second bulk power rails 8, 10 and 38, 40 over the same half of a phase cycle. FIG. 8c shows the signals provided by the sine-wave look up table 94 to the pulse width modulator 92, the magnitudes of the signals being normalised such that a 1V signal represents a 100% duty cycle (it will be understood that, when the controller 42 is digital, the signals provided by the sine-wave look up table 94 are virtual). In order to implement the above expression for Duty1, the signal provided by the sine-wave look up table 94 to the pulse width modulator 92 to control the duty cycle of the first transformer 52 conforms to the equation for Duty1 provided above.

Duty1 is labelled as V(B1_Duty) in FIG. 8c (and is represented by a solid line). As shown in FIG. 8c, this corresponds (over each 60° phase cycle, for an ideal three-phase AC supply) to a concatenation of first and second portions of a sine wave, a first portion of a sine wave from 30° to 60° and a second portion from 60° to 30° .

Similarly, in order to implement the above expression for Duty2, the signal provided by the sine-wave look up table 94 to the pulse width modulator 92 to control the duty cycle of the second transformer 58 conforms to the equation provided for Duty2 above.

Duty2 is labelled as V(B2_Duty) in FIG. 8c (and is represented by a dashed line). As shown in FIG. 8c this corresponds (over each 60° phase cycle, for an ideal three-phase AC supply) to a concatenation of third and fourth scaled portions of a sine wave, a third portion from 30° to 0° and a fourth portion from 0° to 30°.

The pulse width modulator 92 calculates the required values of φ_{PWM1_1}, φ_{PWM1_2}, φ_{PWM2_1} and φ_{PWM2_2} using the relations set out above.

The signals provided by the sine-wave look up table 94 to control the duty cycle of the first transformer 52 are always positive and non-zero, indicating that the duty cycle of the first transformer 52 is always positive and non-zero (i.e. the first transformer continuously supplies electrical energy to the DC output). The signals provided by the sine-wave look up table 94 to control the duty cycle of the second transformer 58 are always greater than or equal to zero, indicating that the duty cycle of the second transformer is always greater than or equal to zero (i.e. for the most part the second transformer supplies electrical energy to the DC output, but at the points at which the duty cycle of the second transformer 58 equals zero, the second transformer 58 does not supply electrical energy to the DC output).

FIG. 8d shows the voltage and current at the DC output 3 for the illustrated half phase cycle of the three-phase AC supply. The voltage and current at the DC output both remain constant (or substantially constant) over this half cycle.

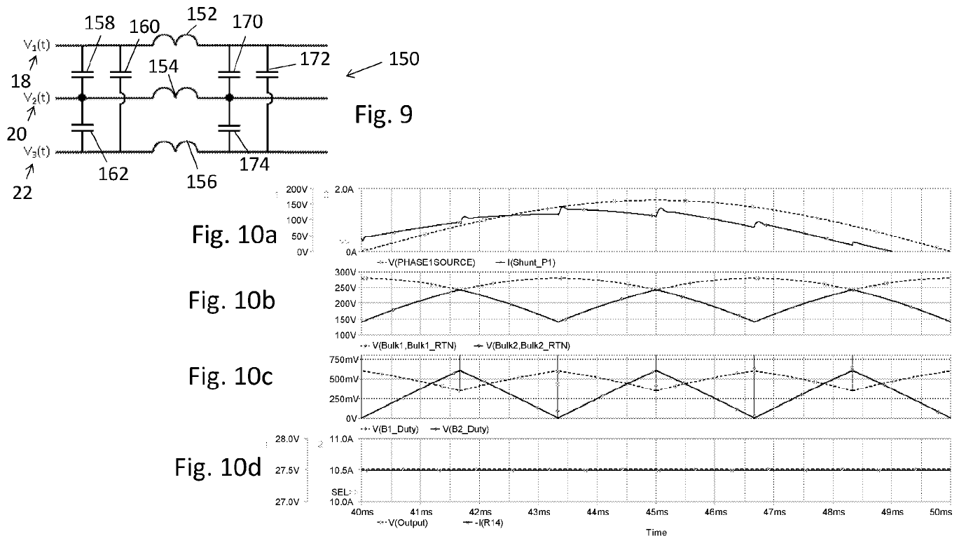

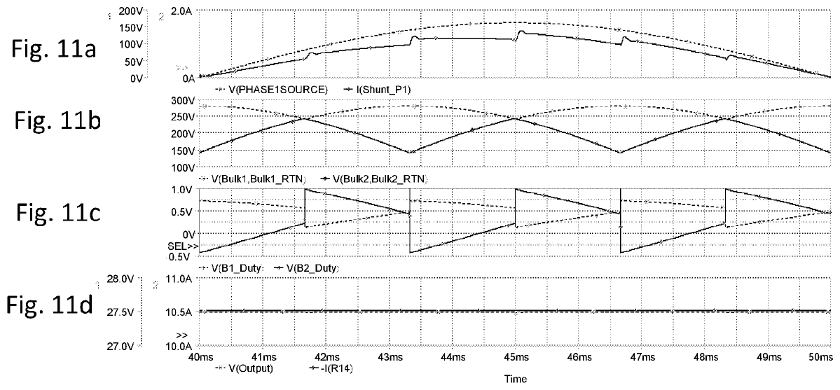

The power converter 1 typically comprises an electromagnetic interference filter 150, such as the one shown in FIG. 9, configured to reduce the line current harmonics fed back into the three phase AC supply from the power converter 1. The electromagnetic interference filter 150 comprises a first inductor 152 connected to the first phase 18, a second inductor 154 connected to the second phase 20 and a third inductor 156 connected to the third phase 22. The filter 150 further comprises a first capacitor 158 connected from a position between the first phase 18 and the first inductor 152 and a position between the second phase 20 and the second inductor 154, a second capacitor 160 connected from a position between the first phase 18 and the first inductor 152 and a position between the third phase 22 and the third inductor 156, and a third capacitor 162 connected from a position between the second phase 20 and the second inductor 154 and a position between the third phase 22 and the third inductor 156. The filter 150 further comprises a fourth capacitor 170 connected from a position between the first inductor 152 and the first and second selectors 4, 12 to a position between the second inductor 154 and the first and second selectors 4, 12, a fifth capacitor 172 connected from a position between the first inductor 152 and the first and second selectors 4, 12 and a position between the third inductor 156 and the first and second selectors 4, 12, and a sixth capacitor 174 connected from a position between the second inductor 154 and the first and second selectors 4, 12 and a position between the third inductor 156 and the first and second selectors 4, 12. These capacitors 158-162, 170-174 produce a phase shift and result in the steps 175 in the current waveform of FIG. 10a (see below). The capacitors are minimised in size to minimise total harmonic distortion.

For the purposes of the following discussion, the simpler electromagnetic interference filter 150 illustrated in FIG. 1 will be considered. In this case, the electromagnetic interference filter 150 consists of respective capacitors 176 each having a value C_{filter} provided across each pair of phases of the three phase supply and connected together in a delta arrangement. The equivalent input filter capacitor (delta-to-star conversion) can be considered to be C_{eq}=3C_{filter}.

The waveforms shown in FIG. 8a above assumed that the phase current and phase voltage within each phase of the three-phase supply were in phase with each other (i.e. that the input power factor of the converter was unity). However, current flow within the capacitors 176 of the electromagnetic interference filter 150 provide the power converter 1 with a power factor lead. This is illustrated by the waveforms shown in FIG. 10a, which show the instantaneous voltage (dotted lines) and current (solid line) drawn from the first phase 18 when there is a leading power factor (the phase current leads the phase voltage) which has not been corrected for. FIGS. 10b and 10c are identical to FIGS. 8b and 8c, but the DC outputs shown in FIG. 10d are lower than those in FIG. 8d due to a 20% load (rather than the 100% load of FIG. 8a) in this example.

The power factor lead introduced by the electromagnetic interference filter 150 can be corrected (brought closer to unity) by adjusting the duty cycles of the first and second transformers 52, 58, thereby varying the relative contributions of the first and second transformers 52, 58 to the DC output 3. This is illustrated in FIG. 11a which shows the instantaneous voltage and current drawn from the first phase 18 in phase with each other.

In order to achieve power factor correction, a non-zero phase compensation term φ needs to be considered in the equations for Duty1 and Duty2. In order to determine φ, the capacitive current magnitude due to C_{eq} must be taken into account. This can be determined from:

I_{Ceq_filter}=ωC_{eq}Vₚₖ

where Vₚₖ is the peak input voltage of one of the phases of the three phase AC supply.

In addition, the capacitive currents passing through capacitors 180, 182 provided between the first power rail portion and its return and between the second power rail portion and its return respectively must also be considered. These can be determined from:

I_{Bulkcap}=ω√6Vrms(0.083C_{Bulk1}+0.205C_{Bulk2})

where C_{Bulk1} is the capacitance of capacitor 180 and C_{Bulk2} is the capacitance of capacitor 182 and Vᵣₘₛ is the line-neutral RMS input voltage of the three phase supply.

The minimum current in the first power rail is defined by:

$${I}_{Bulk 1 \_ min} = {K}_{1} {δ}_{T} sin ( 30 ° ) {I}_{outDC} \frac{{N}_{T 1 s}}{{N}_{T 1 p}}$$

where I_{outDC} is the output DC current.

The maximum current in the second power rail is defined by:

$${I}_{Bulk 2 \_ max} = {K}_{2} {δ}_{T} sin ( 30 ° ) {I}_{outDC} \frac{{N}_{T 2 s}}{{N}_{T 2 p}}$$

The total current delivered to the first and second power rails is:

$${I}_{Bn \_ p k} = {I}_{Bulk 1 \_ min} + {I}_{Bulk 2 \_ max} \\ {I}_{Bn \_ p k} = {K}_{1} {δ}_{T} sin ( 30 ° ) {I}_{outDC} \frac{{N}_{T 1 s}}{{N}_{T 1 p}} + {K}_{2} {δ}_{T} sin ( 30 ° ) {I}_{outDC} \frac{{N}_{T 2 s}}{{N}_{T 2 p}} \\ {I}_{Bn \_ p k} = {K}_{1} {δ}_{T} {I}_{outDC} \frac{{N}_{T 1 s}}{{N}_{T 1 p}}$$

The phase-shift compensation parameter is expressed as:

$$φ = {tan}^{- 1} \frac{( {I}_{Ceq} + {I}_{Bulkcap} )}{{I}_{Bn \_ p k}}$$

In the present example, the following parameters are assumed: Vᵣₘₛ=254V; AC peak line-neutral input voltage, Vₚₖ=359V; frequency of three phase supply, f_{AC}=60 Hz; output power P_{outDC}=3 kW; Output voltage, V_{outDC}=250V; output current, I_{outDC}=12 A; N_{T1p}=16; N_{T1s}=10; N_{T2p}=13; N_{T2s}=6; δ_{T}=0.643; C_{filter}=2400 nF; C_{Bulk1}=680 nF; C_{Bulk2}=1 nF; K₁=1.155 (as above).

In this case:

$${I}_{Ceq \_ filter} = 2 ⊓ ( 60 Hz ) \times 7.2 μ F \times 359 V = 0.975 A \\ {I}_{Bulkcap} = 2 ⊓ ( 60 Hz ) √ 6 \times 254 \times ( ( 0.083 \times 680 n F ) ) = 0.013 A \\ {I}_{Bn \_ p k} = 1.155 \times 0.643 \times 12 \times 10 / 16 = 5.57 A \\ φ = {tan}^{- 1} \frac{( 0.975 + 0.013 )}{5.57} = 0.176 radians ( or 10 ° )$$

Thus, in the present case, power factor correction is achieved by applying a 10° phase shift (a phase lag in the present embodiment) to the Duty1 and Duty2 signals requested from the sine-wave look up table 94 and providing the phase shifted signals to the pulse width modulator 92, as illustrated in FIG. 11c. The repeated sine wave portions from the look up table controlling the duty cycle of the first transformer have been phase shifted from a combination of a 60° to 30° portion of a sine wave and a 30° to 60° portion to a combination of a 70° to 40° portion and a 20° to 50° portion. The repeated sine wave portions from the look up table controlling the duty cycle of the second transformer 58 have been changed from a combination of a 0° to 30° portion of a sine wave and a 30° to 0° portion to a combination of a -10° to 20° portion of a sine wave and a 40° to 10° portion of a sine wave.

As shown in FIG. 11c, this introduces steps (discontinuities) into the signals provided by the sine-wave look up table 94 because, in respect of the signals controlling the duty cycle of the first transformer 52, the magnitude of a sine wave at 40° is not equal to the magnitude of a sine wave at 20° and the magnitude of a sine wave at 50° is not equal to the magnitude of a sine wave at 70°. Similarly, in respect of the signals controlling the duty cycle of the second transformer 58, the magnitude of a sine wave at 20° is not equal to the magnitude of a sine wave at 40° and the magnitude of a sine wave at −10° is not the same as the magnitude of a sine wave at 10°. The signals provided by the sine-wave look up table 94 to control the duty cycle of the first transformer 52 are still always positive and non-zero, indicating that the duty cycle of the first transformer 52 is always positive and non-zero (i.e. the first transformer continuously supplies electrical energy to the DC output). However, for a number of (short) time periods of a phase cycle of the three-phase supply, the signals requested from and provided by the sine-wave look up table 94 to the pulse width modulator 92 to control the duty cycle of the second transformer 58 are negative. This indicates that, for a portion of each phase cycle of the three-phase supply, the duty cycle of the second transformer 58 is negative. That is, for the said portions of each phase cycle of the three-phase supply, the second transformer 58 (and therefore the second bulk power rail 38, 40) consumes electrical energy rather than supplies it to the DC output. This consumed electrical energy is supplied by the first transformer 52, which also solely supplies the DC output during these time periods. Therefore, for these portions of each phase cycle of the three-phase supply, the first transformer 52 (and therefore the first power rail 8, 10) supplies more electrical energy than is required by the DC output 3. For these time periods, it can be said that the second transformer has a negative duty cycle.

The electrical energy consumed by the second transformer 58 during these portions of the phase cycle of the three-phase AC supply is sent back through the secondary winding 61 of the second transformer 58 to the primary winding 56 thereof and ultimately onto the capacitors of the electromagnetic interference filter 150 where it is stored until the duty cycle of the second transformer 58 becomes positive again, when the said electrical energy is discharged from the capacitors through the second selector 12, the second power rail 38, 40 the second inverter 60 and ultimately the second transformer 58. The electrical energy consumed by the second transformer 58 is effectively superimposed onto the capacitors of the electromagnetic interference filter to correct the power factor of the power converter towards unity. This is because the electrical energy consumed by the second transformer is 180° out of phase with the electrical energy provided by the three phase supply (and can therefore be used to correct the power factor lead provided by the electromagnetic interference filter to the electrical energy provided by the three phase supply). Thus, by adding a phase lag to the inverter current loads, the reactive currents in the electromagnetic interference filter which lead the AC voltage may be balanced out, thereby improving power factor. This is particularly important when the load of the converter reduces and the reactive load of the electromagnetic interference filter becomes increasingly significant.

FIGS. 11b and 11d are identical to FIGS. 10b and 10d.

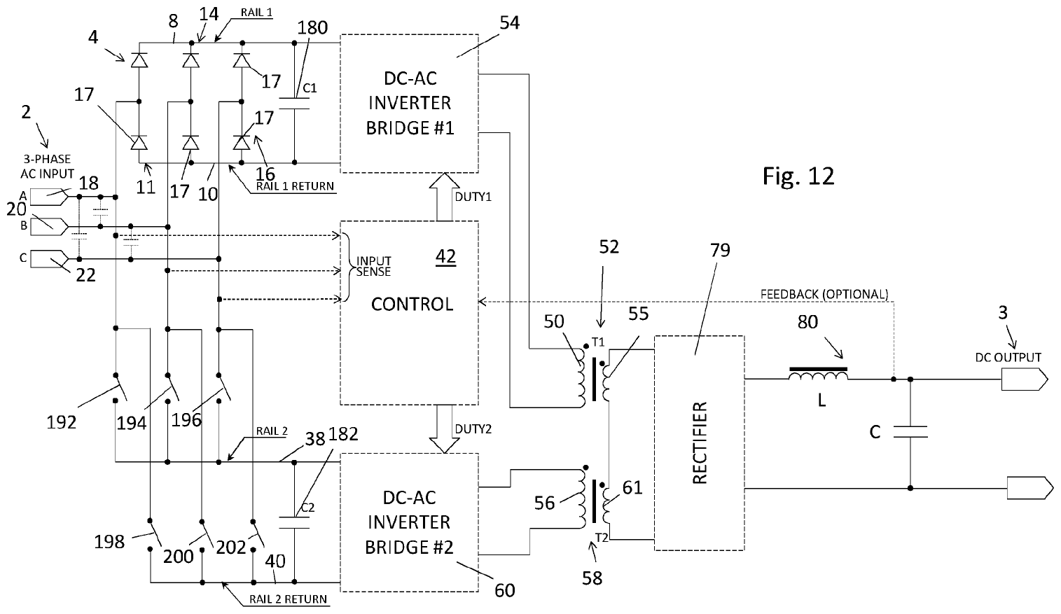

It will be understood that it would not be possible to send electrical energy from the first power rail 8, 10 back to the electromagnetic interference filter 150 by way of the second inverter 60 and the second selector 12 shown in FIG. 1 because the diodes of the second selector 12 are unidirectional. Accordingly an alternative second selector design is employed which allows electrical energy to be sent back from the first power rail 8, 10 to the capacitors of the electromagnetic interference filter 150 by way of the second inverter 60 and the second selector. For example FIG. 12 shows an alternative power converter comprising a second selector 190 comprising six bi-directional switches 192-202, one between the each phase of the three phase supply and the second power rail portion 38 and one between each phase of the three phase supply and the second return power rail portion 40 of the second bulk power rail. Each of the bi-directional switches 192-202 is configurable by the controller 42 (with which each of the switches is in communication) in an open position in which it is configured to block both positive and negative electrical signals and a closed position in which it is configured to allow electrical signals to propagate both from the three phase AC supply to the second bulk power rail 38, 40 and from the first power rail 8, 10 to the capacitors of the electromagnetic interference filter 150 by way of the second inverter 60 and the second selector 190. For example, each of the switches 192-202 may comprise back to back FETs.

The rail 2 control module 130 of the controller 42 (which is provided in communication with the switches 192-202) is configured to open and close the switches 192-202 in phased relationship with the three-phase AC supply to provide the voltage across the second bulk power rail 38, 40 with the second highest instantaneous phase-to-phase voltage of the three-phase AC supply. Again, the controller 42 (e.g. the rail 2 control module 130) uses the phase angle reference provided by the phase reference generator 110 to determine when to open and close each of the switches 192-202 so as to achieve this result.

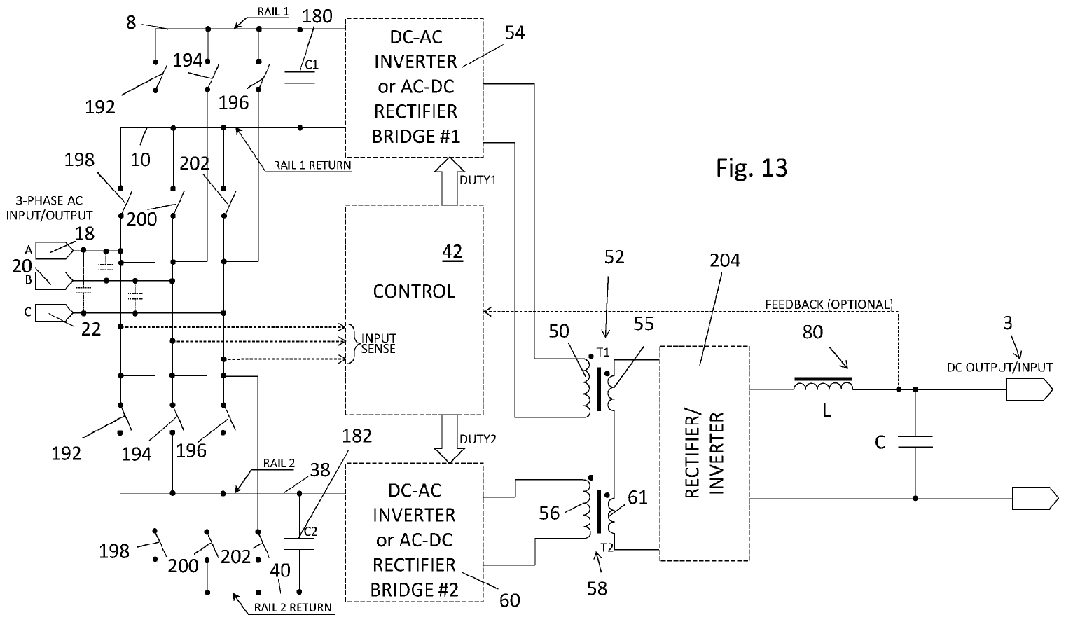

In some embodiments, the power converter 1 has first and second modes: an AC to DC mode and a DC to AC mode. In the AC to DC mode, the power converter is configured to convert a three-phase AC supply to a DC output. In the DC to AC mode the power converter is configured to convert a DC input to a three-phase AC output. That is, it may be that the power converter 1 is a bi-directional power converter. In this case, the first selector 4 shown in FIGS. 1, 12 is also replaced with a selector which permits electrical energy to be fed back to the three-phase AC supply, the diodes 17 of the first selector 4 being unsuitable for this purpose because they are unidirectional. FIG. 13 shows a further alternative power converter where both the first selector and the second selector comprise six bi-directional switches 192-202 configured as described above with reference to FIG. 12. In this case, the controller 42 further comprises a rail 1 control module which, when the power converter is configured in AC to DC mode, is configured to open and close the switches 192-202 of the first selector in phased relationship with the three-phase AC supply to provide the voltage across the first bulk power rail 8, 10 with the highest instantaneous phase-to-phase voltage of the three-phase AC supply. The rail 2 control module 130 is again provided and configured to open and close the switches 192-202 of the second selector in phased relationship with the three-phase AC supply to provide the voltage across the second power rail 38, 40 with the second highest instantaneous phase-to-phase voltage of the three-phase AC supply. The rectifier 79 shown in FIG. 1 which is configured to rectify the combined outputs from the secondary windings 55, 61 of the first and second transformers 52, 58 is replaced with a rectifier bridge 204 comprising a plurality of switches in communication with the controller 42, the rectifier bridge 204 being configurable to operate as a rectifier (providing the same or similar functionality to rectifier 79 of the embodiment of FIG. 1) when the power converter is operating in the AC to DC mode and as a power inverter when the power converter is operating in the DC to AC mode.

When operating in DC to AC mode, the power converter is operated in reverse (i.e. right to left rather than left to right in the view of the schematic of FIG. 13) and the DC input is provided where the DC output was provided in AC to DC mode. The DC signal is then converted by the inverter to produce a high frequency AC voltage signal (e.g. at least 1 kHz, at least 10 kHz or at least 100 kHz) which can be fed to the secondary windings 55, 61 of the first and second transformers. The high frequency AC voltage signal is stepped up to the primary windings 50, 56 before being transmitted to the first and second inverter bridges 54, 60 which are in this mode configured as rectifiers so as to provide the first and second power rails 8, 10 and 38, 40.

As the rectifier bridge 204 must be capable of propagating electrical energy from the transformers 52, 58 to the DC output in the AC to DC mode, and from the DC input to the transformers 52, 58 in the DC to AC mode, the switches of the rectifier bridge 204 (e.g. configured as an H-bridge) must be bi-directional switches configurable in their “on” states to conduct electrical current in both of two opposing directions. It will be understood that, unlike the first and second selectors, the switches of the rectifier bridge 204 do not typically need to block the propagation of electrical current in the said two opposing directions when in their off states because the DC input is typically positive or negative (rather than cycling between positive and negative in the way that the three-phase AC supply does). Accordingly, each of the switches of the rectifier 204 may be implemented by, for example, single FETs.

By being operable in AC to DC mode and in DC to AC mode, the converter can draw in electrical power from the three-phase AC supply (e.g. from the grid) in the AC to DC mode to charge a DC power storage device (e.g. a battery), and in the DC to AC mode to discharge electrical power from the DC power storage device back to the three-phase AC supply (e.g. to the grid). This makes the power converter particularly suitable for renewable energy applications, particularly where the renewable energy source is unreliable, remote from users and/or has to be stored at off-peak times for use at peak times (e.g. wind, tidal or solar power).

A first capacitor 180 is connected in parallel between the first selector and the first inverter bridge, and a second capacitor 182 is connected in parallel between the second selector and the second DC to AC inverter bridge 60. These capacitors 180, 182 provide a current path for high frequency currents at or above the frequency of the respective inverters 54, 60 to minimise electromagnetic compatibility problems and reduce the voltage stress on the bridge FETs and other components. These capacitors 180, 182 will introduce an inherent harmonic current, but this can be minimised by setting the capacitance of the first capacitor 180 equal to twice the capacitance of the second capacitor 182.

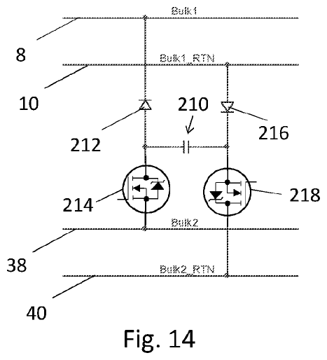

In the event of a fault with the three-phase supply, it may be that the voltages across the respective first and second bulk power rails 8, 10 and 38, 40 will drop significantly. If the fault lasts for long enough, this could lead to an undesirable decrease in the current/voltage of the DC output 3. As shown in FIG. 14, in order to mitigate the risk of this situation occurring, a hold-up capacitor 210 may be coupled to, and between, the first bulk power rail 8, 10 and the second bulk power rail 38, 40. More specifically, a first plate of the hold-up capacitor 210 is connected to the first power rail portion 8 via a first diode 212 (the anode of the first diode 212 being connected to the capacitor 210 and the cathode being connected to the first power rail portion 8) and to the second power rail portion 38 via a second diode 214 which is an antiparallel diode of a first (in this case n-type) MOSFET switch (the gate voltage of which is controlled by controller 42), the anode of the second diode 214 being connected to the second power rail portion 38 and the cathode of the second diode 214 being connected to the capacitor 210, and a second plate of the capacitor 210 opposite the first plate is connected to the first return power rail portion 10 via a third diode 216 (the cathode of the third diode 216 being connected to the capacitor and the anode of the third diode 216 being connected to the first return power rail portion 10) and to the second return power rail portion 40 of via a fourth diode 218 which is an antiparallel diode of a second (in this case n-type) MOSFET switch (the gate voltage of which is controlled by the controller 42), the cathode of the fourth diode being connected to the return 40 and the anode of the fourth diode being connected to the capacitor 210.

In normal operation, assuming that the capacitor 210 is initially discharged, that the first selector provides the first power rail 8, 10 with the highest instantaneous phase to phase voltage and the second selector provides the second power rail 38, 40 with the second highest instantaneous phase to phase voltage and that the initial conditions correspond to the phase voltages at 0° in FIG. 2a, the second power rail portion 38 will have a higher voltage (provided by phase A) than the first plate (left hand plate in FIG. 14) of the capacitor 210. Accordingly, the second diode 214 is forward biased and in an “on” state. The first power rail portion 8 (also provided by phase A) will also have a higher voltage than the first plate of the capacitor 210 and so the first diode 212 is reverse biased and in an “off” state. The second return power rail portion 40 will have a lower voltage (provided by phase C) than the second plate (right hand plate in FIG. 14) of the capacitor 210, so the fourth diode 218 is forward biased and in an “on” state. The first return power rail portion 10 will have a voltage (provided by phase B) less than that of the second plate of the capacitor, so the third diode 216 will be reverse biased and in an “off” state. Accordingly, the first plate charges up towards the voltage of the second power rail portion and the second plate charges up towards the voltage of the second return power rail portion 40.

At around 15°, the voltages of the first and second power rail portions 8, 38 (both provided by phase A at this point) decrease and, because there will be a lag before the first plate of the capacitor 210 discharges in response to the reduced voltage, the voltage of the first plate of the capacitor 210 becomes greater than the voltages of the first and second power rail portions 8, 38. Accordingly, the first diode 212 becomes forward biased and turns on, while the second diode 214 becomes reverse biased and turns off. The first plate of the capacitor 210 therefore becomes connected to the first power rail portion 8 and so the voltage of the first plate follows that of the first power rail portion (provided by phase A). Meanwhile, the voltage of the second return power rail portion 40 (provided by phase C) increases and, because there will be a lag before the second plate reaches the increased voltage, the voltage of the second plate of the capacitor 210 becomes less than the voltage of the second return power rail portion 40, thereby turning off the fourth diode 218. The voltage of the second plate of the capacitor 210 remains above that of the second return power rail portion (which has decreased) and so the third diode 216 remains off.

At a phase of 30°, the second power rail portion 38 switches to phase C and the second return power rail portion 40 switches to phase B, which causes the fourth diode 218 to become forward biased and turn on. The voltage of the second plate of the capacitor therefore follows that of the second return power rail portion 40 (which at 30° is the same as the voltage of the first return power rail portion 10), thereby increasing the voltage across the capacitor 210 towards that across the first power rail.

At a phase of 60°, the first power rail portion 8 switches to phase C and the second power rail portion 38 switches to phase A. Shortly thereafter, the voltage of the first plate of the capacitor starts to increase. As that increase lags the increase in the voltage of the first power rail portion, the first diode 212 turns off. In addition, the voltages of the first and second return power rail portions 10, 40 start to increase and, because the voltage of the second plate of the capacitor 210 lags that of the first and second return power rail portions 10, 40, the third diode 216 turns on and the fourth diode 218 turns off. Thus, the second plate of the capacitor 210 continues to follow the voltage of the first return power rail portion 8.

At a phase of 90°, the second power rail portion 38 switches to phase C and the second return power rail portion 40 switches to phase A. Shortly thereafter, the voltage of the second power rail portion 38 becomes greater than the voltage of the first plate of the capacitor 210, thereby causing the second diode 214 to turn on, thereby connecting the first plate of the capacitor 210 to the second power rail portion 38 (which at 90° is the same as that of the first power rail portion 8). Meanwhile the third diode 216 remains on (connecting the second plate of the capacitor 210 to the first return power rail portion 8) and the fourth diode 218 remains off. Accordingly, the voltage across the capacitor 210 follows the voltage across the first power rail 8, 10.

At a phase of 120°, the first return power rail portion 10 switches to phase A, while the second return power rail portion 40 switches to phase B. Shortly thereafter the voltage of the first return power rail portion 10 decreases, causing the third diode 216 to turn off. The fourth diode 218 remains off. The first plate of the capacitor 210 remains connected to the second power rail portion 38 (which remains the same as that of the first power rail portion 8).

At a phase of 150°, the second power rail portion 38 switches to phase B and the second return power rail portion 40 switches to phase A. This causes the second diode 214 to turn off and, because the voltage of the first power rail portion 8 is decreasing, the voltage of the first plate of the capacitor 210 becomes greater than that of the first power rail portion 8, causing the first diode 212 to turn on and connecting the first plate of the capacitor 210 to the first power rail portion 8. As the second return power rail portion 40 is decreasing, the fourth diode 218 turns on, connecting the second plate of the capacitor 210 to the second return power rail portion 40 (which at 150° is the same as the first return power rail portion 8).

At a phase of 180°, the first power rail portion 8 switches to phase B and the second power rail portion 38 switches to phase C. Shortly thereafter, the voltage of the first power rail portion 8 increases above that of the first plate of the capacitor, thereby turning off the first diode 212. The second power rail portion 38 also decreases, so the second diode 214 remains off. The fourth diode 218 remains on (thereby connecting the second plate of the capacitor 210 to the second return power rail portion 40 which at 180° has the same voltage as the first return power rail portion 10), but shortly thereafter the voltages of the first and second return power rail portions 10, 40 increase, causing the third diode 216 to turn on and the fourth diode 218 to turn off (connecting the second plate of the capacitor to the first return power rail portion). The conditions at this stage are analogous to those at 60°, and the cycle described above between 60° and 180° then repeats during normal operation.

The capacitor is sized so that, when the first and second diodes 212, 214 are off, the first plate of the capacitor 210 does not discharge quickly relative to the frequency of the three phase AC source. Similarly, the capacitor is sized so that, when the third and fourth diodes 216, 218 are off, the second plate of the capacitor does not discharge quickly relative to the frequency of the three phase AC source. The capacitor and the diode switching circuit are thus configured to maintain the voltage across the capacitor 210 at a value greater than or equal to the minimum voltage across the first power rail during normal operation of the three phase supply.

In the event of a fault with the three-phase supply which causes the voltage of the first plate of the capacitor 210 to be greater than the voltage of the first power rail portion 8, and the voltage of the second plate of the capacitor 210 to be less than the voltage of the first return power rail portion 10, the first and third diodes 212, 216 turn on and the capacitor 210 discharges through the first positive and return power rail portions 8, 10, acting as a source of energy to supply to the DC output 3 for a finite time period (i.e. until the capacitor has discharged). In addition, the gate voltages of the MOSFETs comprising diodes 214, 218 are controlled by the controller 42 to turn on in the event of a fault to allow the holdup capacitor 210 to discharge through the second positive and return power rail portions 38, 40, acting as a source of energy to supply to the DC output 3 for a finite time period (i.e. until the capacitor has discharged).The arrangement of the hold-up capacitor 210 ensures that it does not affect any other circuitry of the power converter.

Further modifications and variations may be made within the scope of the invention herein disclosed.

For example, although the present invention has been described in terms of a power converter in which the highest and second highest phase to phase voltages of the three-phase supply are selected to provide the first and second bulk power rails 8, 38, 17 the power converter may alternatively select the highest and lowest phase to phase voltages or the second highest and the lowest phase to phase voltages to provide the first and second bulk power rails 8, 38.

In another example, MOSFETS 214, 218 may be replaced by passive diodes in which case, in the fault detection mode, the holdup capacitor discharges to the DC output through the first power rail 8, 10 but not through the second power rail 38, 40.

The present invention has been described in terms of a variety of possible topologies. The present invention may equally be applied to other possible topologies.

Any diodes provided in the circuitry discussed above may be replaced with any alternative switch (e.g. a bidirectional switch), such as a FET, in communication with the controller 42.

The required turns ratios of the first and second transformers are determined by the required input voltage and output voltage ranges. Precise ratios are not required, only that the transformers are able to provide their output windings with appropriate levels of voltage and current through the AC cycle.

Although in the embodiments described above, the first selector selects the highest instantaneous phase to phase voltage and the second selector selects the second highest instantaneous phase to phase voltage for each 360° cycle of the AC supply, in an alternative embodiment the second power rail portion 38 may be permanently tied to the highest instantaneous phase voltage and the second power rail return portion 40 may be permanently tied to the second highest instantaneous phase voltage. This means that the voltage across the second power rail 38, 40 is sometimes the second highest instantaneous phase to phase voltage, and sometimes the lowest instantaneous phase to phase voltage during a single phase cycle of the AC supply. In this case, a further capacitor may be provided between the first power rail portion 8 and the second power rail portion 38 to help reduce the harmonic content of the supply current drawn.

In another alternative embodiment, the second power rail portion 38 may be permanently tied to the second highest instantaneous phase voltage and the second power rail return portion 40 may be permanently tied to the lowest instantaneous phase voltage. This again means that the voltage across the second power rail 38, 40 is sometimes the second highest instantaneous phase to phase voltage, and sometimes the lowest instantaneous phase to phase voltage during a single phase cycle of the AC supply. In this case, a further capacitor may be provided between the first power rail return portion 10 and the second power rail return portion 40 to help reduce the harmonic content of the supply current drawn.

1. A power converter for converting a three-phase alternating current (AC) supply to a direct current (DC) output, the power converter comprising: a first selector configured to select one of the highest, the second highest or the lowest instantaneous phase to phase voltages of the three-phase supply to provide a first power rail; a second selector configured to select a different one of the highest, the second highest or the lowest instantaneous phase to phase voltages of the three-phase supply to provide a second power rail; a first transformer coupled to the first power rail; a second transformer coupled to the second power rail; a combiner configured to combine the outputs of the first and second transformers to provide the DC output; and a duty cycle controller configured to vary duty cycles of the first and/or second transformers to thereby vary the relative contributions of the first and second power rails to the DC output.

2. The power converter according to claim 1 wherein the first transformer is coupled to the first power rail by way of a first inverter and wherein the second transformer is coupled to the second power rail by way of a second inverter.

3. The power converter according to claim 2 wherein the controller is configured to vary the duty cycle of the first transformer by varying the duty cycle of the first inverter and/or to vary the duty cycle of the second transformer by varying the duty cycle of the second inverter.

4. The power converter according to claim 1 wherein the first selector is configured to select the highest instantaneous phase to phase voltage of the three-phase supply to provide the first power rail.

5. The power converter according to claim 1 wherein the second selector is configured to select the second highest instantaneous phase to phase voltage of the three-phase supply to provide the second power rail.

6. (canceled)

7. The power converter according to claim 1 further comprising an input and an electromagnetic interference filter in communication with the input, wherein the electromagnetic interference filter comprises one or more capacitors, and wherein the duty cycle controller is configured to vary duty cycles of the first and/or second transformers to thereby vary the relative contributions of the first and second transformers in order to correct a power factor lead caused by the electromagnetic interference filter.

8. (canceled)

9. (canceled)

10. The power converter according to claim 7 wherein the duty cycle controller is configured to vary the duty cycles of the first and second transformers such that, for at least a portion of a phase cycle of the three phase supply, the first transformer outputs a greater amount of electrical energy than required by the DC output and a portion of the electrical energy provided by the first transformer is fed back to the electromagnetic interference filter by way of the second transformer to thereby correct the said power factor lead.

11. The power converter according to claim 10 wherein the control signals provided by the duty cycle controller to vary the duty cycles of the first and/or second transformers comprise one or more discontinuities.

12. The power converter according to claim 1 wherein the second selector comprises a plurality of bidirectional switches.

13. The power converter according to claim 12 wherein the controller is configured to control the said bidirectional switches of the second selector in phased relationship with the three phase AC supply to select the said different one of the highest, the second highest or the lowest instantaneous phase to phase voltages of the three-phase supply.

14. The power converter according to claim 1 further comprising a phase reference generator in communication with the duty cycle controller, the phase reference generator being configured to provide the duty cycle controller with a phase angle reference indicative of the instantaneous phase of the three-phase AC supply.

15. (canceled)

16. (canceled)

17. (canceled)

18. The power converter according to claim 1 wherein the power converter is configurable to convert a three-phase AC voltage supply to a DC voltage or DC current output in an AC to DC mode and to convert electrical energy from a DC voltage source to a three-phase AC current output in a DC to AC mode.

19. The power converter according to claim 1 wherein the first selector comprises a plurality of bidirectional switches.

20. The power converter according to claim 19 wherein the controller is configured to control said bidirectional switches of the first selector in phased relationship with the three phase AC supply to select the said one of the highest, the second highest or the lowest instantaneous phase to phase voltages of the three-phase supply.

21. The power converter according to claim 1 wherein the duty cycle controller is configured to vary the duty cycles of the first and/or second transformers to thereby maintain the total harmonic distortion of the line current drawn from each of one or more or each of the phases of the three-phase AC supply at less than 5%.

22. The power converter according to claim 1 wherein the second selector is configured to select the second highest instantaneous phase to phase voltage during a first portion of a 360° cycle of the three phase AC supply and to select the lowest instantaneous phase to phase voltage during a second portion of the said 360° cycle of the three phase AC supply different from the first portion.

23. The power converter according to claim 22 wherein the second selector is configured to select a phase to phase voltage between the highest instantaneous phase voltage and the second highest instantaneous phase voltage for one or more or each 360° cycle of the three phase AC supply.

24. The power converter according to claim 23 wherein the second selector is configured to select a phase to phase voltage between the second highest instantaneous phase voltage and the lowest instantaneous phase voltage for one or more or each 360° cycle of the three phase AC supply.

25. The power converter according to claim 1 wherein the duty cycle controller is configured to vary the duty cycles of the first and/or second transformers to thereby vary the relative contributions of the first and second power rails to the DC output in order to correct a power factor of each of one or more or each of the phases of the three phase supply.

26. A method of converting a three-phase alternating current (AC) supply to a direct current (DC) output, the method comprising: selecting one of the highest, the second highest or the lowest instantaneous phase to phase voltages of the three-phase supply to provide a first power rail; selecting a different one of the highest, the second highest or the lowest instantaneous phase to phase voltages of the three-phase supply to provide a second power rail; coupling the first power rail to a first transformer; coupling the second power rail to a second transformer;
combining outputs of the first and second transformers to provide the DC output; and varying duty cycles of the first and/or second transformers to thereby vary the relative contributions of the first and second power rails to the DC output.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)
